(19) United States
(12) Patent Application Publication
(10) Pub. No.: US 2024/0010573 A1
(43) Pub. Date: Jan. 11, 2024

(54) Methods of Producing Cured CO2 Sequestering Solid Compositions, Systems for Practicing the Same and Cured CO2 Sequestering Solid Compositions Produced Therefrom

(71) Applicant: Blue Planet Systems Corporation, Los Gatos, CA (US)

(72) Inventors: Brent R. Constantz, Los Gatos, CA (US); Joseph M. Incatasciato, Los Gatos, CA (US); Mohamad El Hajj Younes, Los Gatos, CA (US); Seung-Hee Kang, Los Gatos, CA (US); Jacob Schneider, Los Gatos, CA (US)

(21) Appl. No.: 18/039,378

(22) PCT Filed: Dec. 20, 2021
(86) PCT No.: PCT/US2021/064358

§ 371 Date: May 30, 2023

Related U.S. Application Data
(60) Provisional application No. 63/128,483, filed on Dec. 21, 2020.
(60) Provisional application No. 63/128,487, filed on Dec. 21, 2020.

(51) Int. Cl. C04B 40/02; C04B 20/02; C04B 20/04

(52) U.S. Cl. CPC C04B 40/0231; C04B 40/029; C04B 20/023; C04B 20/04; C04B 2111/00017

(57) ABSTRACT

Methods of producing cured CO₂ sequestering solid compositions, e.g., precipitate or aggregate compositions, are provided. Aspects of the methods include preparing an initial CO₂ sequestering solid composition, and then contacting the initial composition with a curing liquid sufficient to produce a cured CO₂ sequestering solid composition. Also provided are systems for performing the methods and cured CO₂ sequestering solid compositions produced therefrom.

### CROSS-REFERENCE TO RELATED APPLICATIONS

Pursuant to 35 U.S.C. § 119(e), this application claims priority to the filing dates of U.S. Provisional Application Ser. No. 63/128,487 filed on Dec. 21, 2020, and U.S. Provisional Application Ser. No. 63/128,483 filed Dec. 21, 2020; the disclosures of which applications are herein incorporated by reference.

### INTRODUCTION

Carbon dioxide (CO₂) is a naturally occurring chemical compound that is present in Earth's atmosphere as a gas. Sources of atmospheric CO₂ are varied, and include humans and other living organisms that produce CO₂ in the process of respiration, as well as other naturally occurring sources, such as volcanoes, hot springs, and geysers.

Additional major sources of atmospheric CO₂ include industrial plants. Many types of industrial plants (including cement plants, refineries, steel mills and power plants) combust various carbon-based fuels, such as fossil fuels and syngases. Fossil fuels that are employed include coal, natural gas, oil, petroleum coke and biofuels. Fuels are also derived from tar sands, oil shale, coal liquids, and coal gasification and biofuels that are made via syngas.

The environmental effects of CO₂ are of significant interest. CO₂ is commonly viewed as a greenhouse gas. Because human activities since the industrial revolution have rapidly increased concentrations of atmospheric CO₂, anthropogenic CO₂ has been implicated in global warming and climate change, as well as increasing oceanic bicarbonate concentration. Ocean uptake of fossil fuel CO₂ is now proceeding at about 1 million metric tons of CO₂ per hour.

Concerns over anthropogenic climate change and ocean acidification, have fueled an urgency to discover scalable, cost effective, methods of carbon capture and sequestration (CCS). Typically, methods of CCS separate pure CO₂ from complex flue streams, compress the purified CO₂, and finally inject it into underground saline reservoirs for geologic sequestration. These multiple steps are very energy and capital intensive.

### SUMMARY

Methods of producing cured CO₂ sequestering solid compositions, e.g., precipitate or aggregate compositions, are provided. Aspects of the methods include preparing an initial CO₂ sequestering solid composition, and then contacting the initial composition with a curing liquid sufficient to produce a cured CO₂ sequestering solid composition. Also provided are systems for performing the methods and cured CO₂ sequestering solid compositions produced therefrom.

### BRIEF DESCRIPTION OF THE FIGURES

The present disclosure may be better understood, and its numerous features and advantages made apparent to those skilled in the art by referencing the accompanying drawings. The figures depict various embodiments of the present invention for purposes of illustration only. One skilled in the art will readily recognize from the following discussion that alternative embodiments of the structures and methods illustrated herein may be employed without departing from the principles of the invention described herein. The use of the same reference symbols in different drawings indicates similar or identical items.

FIG. 1 depicts a system for generating durable CO₂ sequestering solid compositions, e.g., aggregate compositions, according to one embodiment of the invention.

FIG. 2 depicts a method of curing CO₂ sequestering solid compositions, e.g., precipitate compositions, according to one embodiment of the invention, with dashed lines depicting optional steps.

FIG. 3A illustrates the effect of washing and curing CaCO₃ aggregates.

FIG. 3B illustrates the effect of washing and curing CaCO₃ coated aggregates.

FIG. 4 illustrates SEM images of original slurry (unwashed), washed and agglomerated aggregate, and final aggregate after curing.

FIG. 5A illustrates the effect of washing and curing on old slurries.

FIG. 5B illustrates the effect of sodium and pH in wash solution.

FIG. 6 depicts an embodiment of a method to generate durable CaCO₃ aggregates and sand by curing slurry from CO₂ gas absorption process.

FIG. 7 illustrates the strength of aggregates made from slurry curing, where the slurry is cured without agglomeration.

FIG. 8A illustrates a closed steam treatement system to wash the CO₂ sequestering solid prior to curing.

FIG. 8B illustrates an open steam treatment system to wash the CO₂ sequestering solid prior to curing.

### DETAILED DESCRIPTION

Methods of producing cured CO₂ sequestering solid compositions, e.g., precipitate or aggregate compositions, are provided. Aspects of the methods include preparing an initial CO₂ sequestering solid composition, and then contacting the initial composition with a curing liquid sufficient to produce a cured CO₂ sequestering solid composition. Also provided are systems for performing the methods and cured CO₂ sequestering solid compositions produced therefrom.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

### Methods

As summarized above, aspects of the invention include methods of producing durable cured CO₂ sequestering solids. As used herein, “curing” means altering the chemical composition of a compound. In one embodiment, curing includes changing a compound in the initial CO₂ sequestering solid composition (hereinafter also referred to as the “initial solid”) from a first polymorph to a second polymorph. Accordingly, in some embodiments, the initial solid includes a first polymorph of calcium carbonate and the curing step converts some or all of the first polymorph of calcium carbonate into a second polymorph of calcium carbonate. The term “polymorph” refers to compounds that have the same empirical formula but different crystal structures. “Empirical formula” refers to the ratio of atoms in a molecule, e.g., the empirical formula of water is H₂O. Calcite, aragonite, and vaterite are polymorphs of calcium carbonate (CaCO₃) since they all have the same empirical formula of CaCO₃, but they differ from each other in crystal structure. Crystal structure space groups of calcite, aragonite, and vaterite are R3c, Pmcn, and P6₃/mmc, respectively. In some cases, the polymorph is amorphous, i.e., wherein the solid is not crystalized and instead lacks long-range order. For example, the solid might include amorphous calcium carbonate. In some cases, the first crystal structure is vaterite or amorphous calcium carbonate, and the second crystal structure is aragonite or calcite. In other embodiments, curing includes changing a first compound into a second compound, i.e., wherein the empirical formula of the compound changes during the curing.

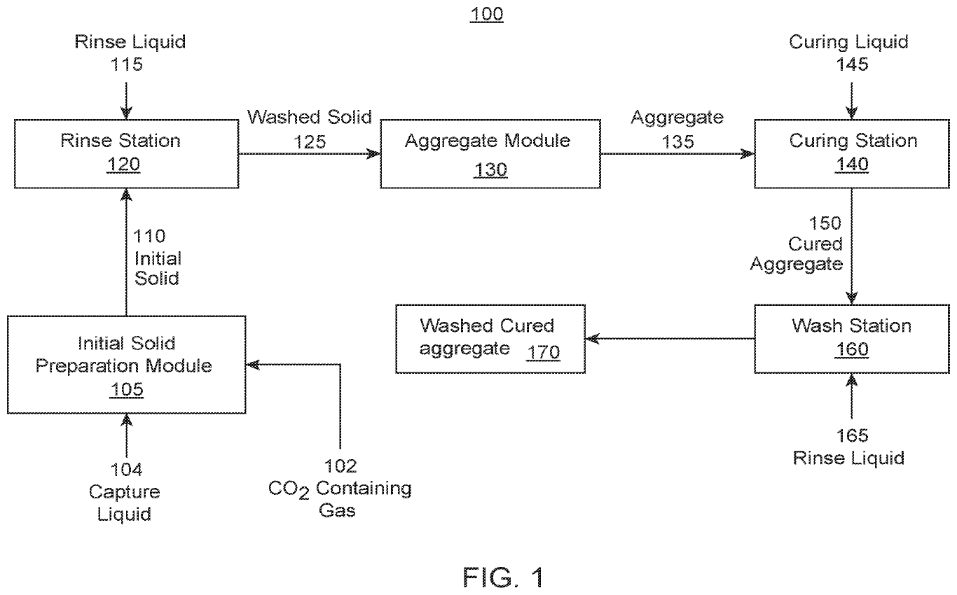

FIG. 1 depicts an embodiment of a system 100 for generating durable CO₂ sequestering solid compositions from an initial CO₂ sequestering solid composition 110. System 100 includes a plurality of modules, each of which can be independently configured for batch operation or continuous operation, i.e., flow operation, in some embodiments. In batch operation, a certain amount of compounds are mixed together in the module, the compounds are allowed to react for a certain amount of time without new compounds being added, and then the products are removed from the module. For example, if a curing module is configured for batch operation, the initial CO₂ sequestering solid composition and curing liquid are added to the module, and the resulting cured CO₂ sequestering solid is removed from the module before additional initial CO₂ sequestering solid composition is added. In continuous operation or flow operation, the inputs are continuously flowed into the module and the outputs are continuously flowed out of the module.

In some embodiments, system 100 includes an initial CO₂ sequestering solid composition preparation module 105. In some cases, module 105 has an intake for a CO₂-containing gas 102, and intake for an aqueous capture liquid 104, and output for the initial CO₂ sequestering solid composition 110. Module 105 is configured to contact a CO₂-containing gas 102 with an aqueous capture liquid 104 and a cation source and produce the initial CO₂ sequestering solid composition 110. In some cases, this production includes a first section of the module 105, wherein the aqueous capture liquid is contacted with the gaseous source of CO₂ 102 to produce an aqueous liquid, and a second section of the module 105 wherein the aqueous liquid is contacted with a cation source to produce the initial CO₂ sequestering solid composition 110. In other cases, the production includes contacting aqueous capture liquid 104 comprising a cation source with a gaseous source of CO₂ 102 to produce the initial CO₂ sequestering solid composition 110. In such a case, the cation source is a part of the capture liquid 104 before the capture liquid is contacted with the gaseous source of CO₂ 102.

In some embodiments, an initial CO₂ sequestering solid composition 110 is a composition that stores a significant amount of CO₂ in a storage-stable format, such that CO₂ gas is not readily produced from the material and released into the atmosphere. In some cases, the initial CO₂ sequestering solid composition includes 5% or more of CO₂ by mass, such as 10% or more, 25% or more, 30% or more, 40% or more, or 45% or more. For example, the solid composition 110 can include CO₂ stored as the carbonate ion (CO₃²⁻). In other words, the solid composition 110 can include carbonate. The amount of carbonate in the initial CO₂ sequestering solid composition 110, e.g., as determined by coulometry, can be 10% or more, such as 25% or more, 50% or more, 60% or more. In some cases, the CO₂ is stored as an alkaline earth metal carbonate, e.g., calcium carbonate, magnesium carbonate, as an alkali earth metal carbonate, e.g., sodium carbonate, potassium carbonate, or a combination thereof.

The initial CO₂ sequestering solid composition 110 provides for long-term storage of CO₂ in a manner such that CO₂ is sequestered (i.e., fixed) in the material, wherein the sequestered CO₂ does not become part of the atmosphere. When the solid composition is maintained under conditions convention for its intended use, the solid composition 110 keeps sequestered CO₂ fixed for extended periods of time, such as 1 year or longer, 5 years or longer, 10 years or longer, 25 years or longer, or 50 years or longer, with significant, if any, release of CO₂ from the solid composition 110. For instance, when the solid composition 110 is maintained in a manner consistent with its intended use, the amount of CO₂ gas released from the solid composition is 10% or less of the total amount of CO₂ in the solid composition per year, such as 5% or less or 1% or less when exposed to normal conditions of temperature and moisture, including rainfall of normal pH, for there intended use, for at least 1, 2, 5, 10, or 20 years, or for more than 20 years, for example, for more than 100 years. Any suitable surrogate marker or test that is reasonably able to predict such stability may be used. For example, an accelerated test comprising conditions of elevated temperature and/or moderate to more extreme pH conditions is reasonably able to indicate stability over extended periods of time. For example, depending on the intended use and environment of the composition, a sample of the initial CO₂ sequestering solid composition 110 may be exposed to 50, 75, 90, 100, 120, or 150° C. for 1, 2, 5, 25, 50, 100, 200, or 500 days at between 10% and 50% relative humidity, and a loss less than 1%, 2%, 3%, 4%, 5%, 10%, 20%, 30%, or 50% of its carbon may be considered sufficient evidence of stability of the solid composition for a given period (e.g., 1, 10, 100, 1000, or more than 1000 years). The CO₂ sequestering materials may have an isotopic profile that identifies the component as being of fossil fuel origin or from modern plants, both fractionating the CO₂ during photosynthesis, and therefore as being CO₂ sequestering. For example, in some embodiments the carbon atoms in the CO₂ materials reflect the relative carbon isotope composition (δ¹³C) of the fossil fuel (e.g., coal, oil, natural gas, tar sand, trees, grasses, agricultural plants) from which the plant-derived CO₂, both fossil or modern, that was used to make the material was derived. In addition to, or alternatively to, carbon isotope profiling, other isotopic profiles, such as those of oxygen (δ¹⁸O), nitrogen (δ¹⁵N), sulfur (δ³⁴S), and other trace elements may also be used to identify a fossil fuel source that was used to produce an industrial CO₂ source from which a CO₂ sequestering material is derived. For example, another marker of interest is (δ¹⁸O). Isotopic profiles that may be employed as an identifier of CO₂ sequestering materials of the invention are further described in U.S. patent application Ser. No. 14/112,495 issued as U.S. Pat. No. 9,714,406; the disclosure of which is herein incorporated by reference.

The term “solid composition” in “initial CO₂ sequestering solid composition” means that there are one or more compounds in the solid state of matter. In other words, at least a part, if not all, of the initial CO₂ sequestering solid composition 110 is in the solid state of matter. In some cases, the solid composition includes a solid and a liquid. In some cases, the solid composition includes a solid but no liquid, i.e., the solid composition includes a dry solid. In some cases, the initial CO₂ sequestering solid composition includes a solid that stores a significant amount of CO₂ in a storage-stable format, such that CO₂ gas is not readily produced from the material and released into the atmosphere, as described above. In some cases, the solid of the solid composition includes a “precipitate”, which is a solid that is formed by a chemical reaction. For example, the precipitate can be a CO₂ sequestering precipitate, e.g., it can include a carbonate compound. For instance, if gaseous CO₂ is contacted with an aqueous solution including a cation source, then one possible product is solid particles including a carbonate compound formed by the chemical reaction between the cation source and the gaseous CO₂. Since the particles are formed by the chemical reaction between CO₂ and cation source, they are referred to herein as a precipitate. If this precipitate is subjected to a physical manipulation that changes the size, shape, or both of the solid, then the resulting solid is referred to as an “aggregate”. In some cases, the aggregate is a solid resulting from a manipulation that increased the size of the precipitate solid, e.g., an aggregate with a larger length, width, height, diameter, or a combination thereof compared to the precipitate. In some cases, forming the precipitate into an aggregate includes removal of a component, such as separation of water from the precipitate by filtration. In some cases, forming the precipitate into aggregate includes addition of a component, such as adding a binding compound. For example, the precipitate can be combined with cement to form concrete aggregates. In some cases the precipitate is formed into aggregate before the curing, in some cases the precipitate is formed into aggregate after the curing, and in some cases no aggregate is formed and the resulting cured solid is a precipitate.

The initial CO₂ sequestering solid composition 110 may be prepared using any convenient protocol. In embodiments, the protocol includes employing a source of CO₂, such as anthropogenic CO₂, in a process that produces the initial CO₂ sequestering solid composition. For example, the CO₂ 102 can be chemically converted into a carbonate compound, i.e., a compound that includes the carbonate ion (CO₃²⁻). The carbonate compounds may include a number of different cations, such as but not limited to ionic species of: calcium, magnesium, sodium, potassium, sulfur, boron, silicon, strontium, and combinations thereof. Of interest are carbonate compounds of divalent metal cations, such as calcium and magnesium carbonate compounds. Specific carbonate compounds of interest include, but are not limited to: calcium carbonate minerals, magnesium carbonate minerals and calcium magnesium carbonate minerals. Calcium carbonate minerals of interest include, but are not limited to: calcite (CaCO₃), aragonite (CaCO₃), vaterite (CaCO₃), ikaite (CaCO₃·6H₂O), and amorphous calcium carbonate (CaCO₃). Magnesium carbonate minerals of interest include, but are not limited to magnesite (MgCO₃), barringtonite (MgCO₃·2H₂O), nesquehonite (MgCO₃·3H₂O), lanfordite (MgCO₃·5H₂), hydromagnisite, and amorphous magnesium calcium carbonate (MgCO₃). Calcium magnesium carbonate minerals of interest include, but are not limited to dolomite (CaMg)(CO₃)₂), huntite (Mg₃Ca(CO₃)₄) and sergeevite (Ca₂Mg₁₁(CO₃)₁₃·H₂O). The carbonate compounds of the product may include one or more waters of hydration, or may be anhydrous. In some instances, the amount by weight of magnesium carbonate compounds in the precipitate exceeds the amount by weight of calcium carbonate compounds in the precipitate. For example, the amount by weight of magnesium carbonate compounds in the precipitate may exceed the amount by weight calcium carbonate compounds in the precipitate by 5% or more, such as 10% or more, 15% or more, 20% or more, 25% or more, 30% or more. In some instances, the weight ratio of magnesium carbonate compounds to calcium carbonate compounds in the precipitate ranges from 1.5-5 to 1, such as 2-4 to 1 including 2-3 to 1. In some instances, the precipitated product may include hydroxides, such as divalent metal ion hydroxides, e.g., calcium and/or magnesium hydroxides.

Exemplary carbonate compounds include those of the formula MCO₃, wherein M is a divalent positive ion, e.g., an alkali earth metal cation such as Ca²⁺ or Mg²⁺. In other cases, the carbonate compound has the formula M₂CO₃, where each M is independently a monovalent positive ion, e.g., an alkali metal cation such as Na⁺ or K⁺ or the ammonium cation (NH₄⁺). In some cases the CO₂ 102 is chemically converted into a bicarbonate compound, i.e., a compound that includes the bicarbonate ion (HCO₃⁻). For instance, the bicarbonate compound can have the formula MHCO₃, wherein M is a monovalent positive ion, e.g., an alkali metal cation such as Na⁺ or K⁺ or the ammonium cation (NH₄⁺). In some cases, the CO₂ 102 is converted into a mixture of carbonate ions and bicarbonate ions. In other words, the initial CO₂ sequestering solid composition 110 includes a mixture of one or more carbonate compounds and one or more bicarbonate compounds.

The CO₂ 102 undergoing the chemical reaction can be in any suitable state of matter, e.g., gaseous CO₂ or CO₂ dissolved in a liquid, such as water (CO_{2(aq)}). In some embodiments, the source of CO₂ 102 can be pure CO₂ or be a multi-component gas including CO₂ (i.e., a multi-component gaseous stream). For example, the gaseous source can be a combustion module that provides CO₂ 102 as a part of a combustion byproduct gas. In some cases the multi-component gas is a flue gas. A waste stream of interest is industrial plant exhaust gas, e.g., a flue gas. By “flue gas” is meant a gas that is obtained from the products of combustion from burning a fossil or biomass fuel that are then directed to the smokestack, also known as the flue of an industrial plant. In certain embodiments, the CO₂ containing gas 102 is obtained from an industrial plant, e.g., where the CO₂ containing gas 102 is a waste feed from an industrial plant. Industrial plants from which the CO₂ containing gas 102 may be obtained, e.g., as a waste feed from the industrial plant, may vary. Industrial plants of interest include, but are not limited to, power plants and industrial product manufacturing plants, such as, but not limited to, chemical and mechanical processing plants, refineries, cement plants, steel plants, etc., as well as other industrial plants that produce CO₂ as a byproduct of fuel combustion or other processing step (such as calcination by a cement plant). Waste feeds of interest include gaseous streams that are produced by an industrial plant, for example as a secondary or incidental product, of a process carried out by the industrial plant.

In some cases, the production of the initial CO₂ sequestering solid composition 110 is mediated through a carbonate intermediate. For example, in some cases the CO₂ gas 102 is contacted with a capture liquid such that the majority of the CO₂ become carbonate, as opposed to bicarbonate. For instance, the preference towards carbonate can be achieved by having a higher pH. Then, a cation intermediate can be added, converting the aqueous carbonate to a solid carbonate. Further details regarding carbonate mediated production protocols are found in U.S. Pat. Nos. 7,744,761; 7,771,684; 7,829,053; 7,914,685; 7,922,809; 7,931,809; 7,939,336; 8,006,446; 8,062,418; 8,114,214; 8,137,455; and 8,177,909; the disclosures of which are incorporated herein by reference.

In some cases the CO₂ gas 102 is contacted with a capture liquid 104 to produce a bicarbonate containing liquid wherein the majority of the CO₂ becomes bicarbonate, as opposed to carbonate. Then, the liquid capture is contacted with a cation source such that two moles of bicarbonate form one mole of carbonate solid and one mole of CO₂ gas. This allows for CO₂ to be sequestered without needing to convert the bicarbonate to carbonate, e.g., via raising the pH, before addition of the cation source. The bicarbonate mediated process can also be performed when the cation source is already part of the capture liquid when it is contacted with the CO₂ gas 102. Additional details regarding bicarbonate mediated production methods, such as described above, are found in U.S. Pat. Nos. 7,815,880; 8,177,909; 8,333,944; 9,707,513; 9,714,406; 9,993,799; 10,197,747; 10,711,236; 10,322,371; and 10,766,015; as well as PCT Patent Publication Nos. WO2016160612; WO2018160888; and WO2020047243; the disclosures of which are herein by reference.

In some embodiments, the aqueous capture liquid 104 comprises aqueous capture ammonia to produce an aqueous ammonium carbonate. The aqueous ammonium carbonate may vary, where in some instances the aqueous ammonium carbonate comprises at least one of ammonium carbonate and ammonium bicarbonate and in some instances comprises both ammonium carbonate and ammonium bicarbonate. When the aqueous capture liquid 104 comprises an aqueous capture ammonia, contacting this liquid 104 with a cation source generates the initial CO₂ sequestering solid composition 110. Further details regarding such ammonia mediated production protocols are found in U.S. Pat. No. 10,322,371, the disclosure of which is incorporated herein by reference.

In some embodiments, the temperature of the capture liquid 104 that is contacted with CO₂-containing gas 102 may vary. In some instances, the temperature ranges from −1.4 to 100° C., such as 20 to 80° C. and including 40 to 70° C. In some instances, the temperature may range from −1.4 to 50 ° C. or higher, such as from −1.1 to 45 ° C. or higher. In some instances, cooler temperatures are employed, where such temperatures may range from −1.4 to 4° C., such as −1.1 to 0° C. In some instances, warmer temperatures are employed. For example, the temperature of the capture liquid 104 in some instances may be 25° C. or higher, such as 30° C. or higher, and may in some embodiments range from 25 to 50° C., such as 30 to 40° C.

In some embodiments, the CO₂-containing gas 102 and the capture liquid 104 are contacted at a pressure suitable for production of a desired CO₂ charged liquid. In some instances, the pressure of the contact conditions is selected to provide for optimal CO₂ absorption, where such pressures may range from 1 ATM to 100 ATM, such as 1 to 50 ATM, e.g., 20-30 ATM or 1 ATM to 10 ATM. Where contact occurs at a location that is naturally at 1 ATM, the pressure may be increased to the desired pressure using any convenient protocol. In some instances, contact occurs where the optimal pressure is present, e.g., at a location under the surface of a body of water, such as an ocean or sea. In some instances, contact of the CO₂-containing gas 102 and the alkaline aqueous medium 104 occurs a depth below the surface of the water (e.g., the surface of the ocean), where the depth may range in some instances from 10 to 1000 meters, such as 10 to 100 meters. In some instances, the CO₂ containing gas 102 and CO₂ capture liquid 104 are contacted at a pressure that provides for selective absorption of CO₂ from the gas, relative to other gases in the CO₂ containing gas, such as N₂, etc. In these instances, the pressure at which the CO₂ containing gas 102 and capture liquid 104 are contacted may vary, ranging from 1 to 100 atmospheres (atm), such as 1 to 10 atm and including 20 to 50 atm.

After formation of the intermediary, one or more reagents are reacted with the intermediary, thereby producing the CO₂ sequestering solid of the initial CO₂ sequestering solid composition 110. In some embodiments, the reagents that cause the sequestration of CO₂ can be in any suitable state of matter, e.g., dissolved in a liquid such as water, gaseous, solid, or liquid. In some cases these reagents provide a cation that converts the intermediary into a CO₂ sequestering compound. For example, the reagent might include a divalent cation, e.g., an alkali earth metal cation such as Ca²⁺ or Mg²⁺, that can interact with the intermediary, e.g., which includes a bicarbonate or carbonate ion, to form a CO₂ sequestering compound, e.g., a divalent cation-carbonate compound, such as calcium carbonate or magnesium carbonate. In some cases, the reagent modifies the pH of a liquid in contact with the intermediary. For instance, the reagent can raise the pH of the capture liquid, which could cause the conversion of an intermediate compound, e.g., a bicarbonate compound, to a carbonate compound that is a CO₂ sequestering compound.

In some cases, the reagent both supplies a divalent cation and raises the pH of the capture liquid. In some cases, the reagent comprises a divalent alkaline earth metal cation, e.g., Ca²⁺ and Mg²⁺. For instance, the reagent can include calcium hydroxide (Ca(OH)₂) or magnesium hydroxide (Mg(OH)₂), either as solids Ca(OH)₂(s) and MgCl₂(s), or as aqueous liquids Ca(OH)₂(aq) and MgCl₂(aq), which can raise the pH of the capture liquid, thereby favoring the carbonate ion, and also provide a divalent cation that can interact with the carbonate to form a CO₂ sequestering carbonate compound.

In some cases, the reagent comprises a transition metal cation, e.g., a period 4 transition metal cation such as Mn, Fe, Ni, Cu, Co, or Zn. In some embodiments, the transition metal cation becomes part of a transition metal carbonate in the CO₂ sequestering solid, e.g., as MnCO₃, FeCO₃, NiCO₃, CuCO₃, CoCO₃, ZnCO₃. In some cases the transition metal is part of pigment, i.e., a color imparting compound that causes the CO₂ sequestering solid to have a different color than a reference solid that does not have the transition metal carbonate. The solid with the transition metal compound can have any color, e.g., red, orange, brown, yellow, green, cyan, blue, purple, magenta, black, gray, or white. Further details regarding use of transition metal cations, e.g., in the production of pigmented products, are provided in U.S. Pat. No. 10,287,439; the disclosure of which is herein incorporated by reference.

As an example, at module 105, the capture liquid 104 and gaseous CO₂ 102 are contacted with a liquid-gas contactor and a solid precipitate identified as calcium carbonate (CaCO₃) is formed.

System 100 includes a rinse station 120 for dewatering and washing or rinsing the initial CO₂ sequestering solid composition 110 with a rinse liquid 115 to generate dewatered and washed solid composition 125. The rinse liquid 115 may vary as desired, and in some embodiments, the rinse liquid 115 is the same as a curing liquid 145 or as the rinse liquid 165. Washing may be achieved using any convenient protocol, such as solid/liquid contacting protocols, such as described below.

System 100 includes an aggregate production module 130 for shaping and forming the washed solid composition 125 into an aggregate 135. In some embodiments the shaping of washed solid composition 125 in aggregate production module 130 may use mechanical methods to form aggregate 135. In other embodiments the shaping of washed solid composition 125 in aggregate production module 130 may use a combination of mechanical methods and applied heat to form aggregate 135. For example, in one embodiment, the aggregate production module 130 is configures such so the washed solid composition 125 is shaped first by a pin mixer and is then fed into a rotating drum where it tumbles for a short period of time in the presence of heat to yield aggregate 135, which then enters a curing module 140.

The curing module 140 can be configured to contact solid composition 125, which may be set (e.g., as described above) with a curing liquid 145 and thereby produce a cured CO₂ sequestering solid 150. Curing means that the two elements are placed in physical proximity to one another such that they can chemically interact and the solid composition can be cured.

In some cases, the curing module 140 has a nozzle for spraying the solid composition 125 with curing liquid. In some cases, the curing module 140 is configured to submerge the solid composition 125 in the curing liquid 145. In some cases, the curing module 140 includes a curing liquid 145 positioned within a reservoir of the curing module 140. The curing liquid 145 positioned within the reservoir of the curing module 140 can have any of the properties described above.

In some cases, the curing module 140 is configured to cure the solid composition 125 for a period of time ranging from 1 minute to 50 days, such as 1 hour to 40 days, such as 1 day to 30 days, or 7 days to 21 days. In some cases, the curing module 140 includes a heater for increasing the temperature of the curing liquid 145, e.g., to 30° C. to 50° C. or higher, e.g., 80° C. In some cases, the curing module 140 is configured so that the curing liquid 145 is at a temperature ranging from 15° C. to 80° C., such as 17° C. to 50° C., e.g., 20° C. to 50° C., including 30° C. to 50° C., where in some instances the range is 17° C. to 25° C., for at least a portion of the curing, e.g., for the entire length of the curing. As such, the curing module 140 can have a heater configured to heat the curing liquid 145 and the aggregate 135.

In some embodiments, the curing liquid 145 is a composition that can be contacted with the solid composition 125, thereby curing it and producing the cured CO₂ sequestering solid composition 150. In some embodiments, curing module 140 includes a single curing step, or two or more distinct curing steps, as desired. Where multiple curing steps are employed, the curing liquid 145 employed in each of the multiple steps may be the same or different. As such, in some instances, the solid composition 125 is subjected to multiple curing steps with the same curing liquid 145. In other instances, the solid composition 125 is subjected to multiple curing steps with different curing liquids 145.

The term “liquid” in “curing liquid” 145 means that the curing composition includes a compound in a liquid state of matter, e.g., water. For example, the curing liquid 145 can be an aqueous liquid, such that water is the most abundant compound present in the curing liquid. In some cases, the curing liquid 145 is substantially free or completely free of any compounds dissolved in the water of the aqueous curing liquid. In other embodiments, the curing liquid 145 includes water and compounds dissolved in the water, i.e., the curing liquid is a solution that includes solutes dissolved in a solvent. In some cases, the curing liquid 145 also includes a compound in a solid state of matter, i.e., a solid compound that is not dissolved in the liquid. In some embodiments, the curing liquid 145 is an emulsion, i.e., it is a mixture of two or more liquids that normally form two immiscible layers, but wherein addition of an emulsifier causes the two layers to merge and form a single layer.

In some cases, the curing liquid 145 has a dissolved inorganic carbon concentration sufficient to produce the desired cured composition. Dissolved inorganic carbon (DIC) refers to carbonate ions (CO₃²⁻), bicarbonate ions (HCO₃), and CO₂ dissolved in a liquid. In some instances, the curing liquid 145 has a DIC ranging from 0.01 M to 10 M, such as from 0.05 M to 5 M, 0.1 M to 4 M, or 0.5 M to 3 M. For example, if the curing liquid 145 includes 1 M of carbonate ions, 0.2 M of bicarbonate ions, and 0.1 M of dissolved CO₂, then the dissolved inorganic carbon concentration will be 1.3 M. In some cases, the curing liquid 145 has concentration of positive ions ranging from 0.01 M to 10 M, such as from 0.05 M to 5 M, 0.1 M to 4 M, or 0.5 M to 3 M, e.g., wherein the positive ion is selected from the group consisting of Na⁺, K⁺, and NH₄⁺. For example, in some cases the curing liquid 145 has a concentration of Na⁺ ions ranging from 0.5 M to 5 M.

In some instances, the curing liquid 145 allows for the temporary dissolution of solid compounds into the curing liquid 145, followed by a transition of these compounds back into a solid state, but in a second crystal structure. In some cases the curing liquid 145 favors the formation of the second crystal structure over formation of the first crystal structure. In some embodiments, the curing liquid 145 includes an ion, e.g., carbonate, that is also present in the initial CO₂ sequestering composition. Due to limitation on solubility, the presence of this ion in the curing liquid 145 can help prevent an undesirably high amount of the initial CO₂ sequestering composition 110 from dissolving in the curing liquid 145 and remaining in the curing liquid 145. In other words, the presence of this common ion can favor the transition of the compound back into a solid state, but in the second crystal structure. In other cases, the curing liquid 145 can directly interact with the solid in the first crystal structure and cause it to change into the second crystal structure without dissolving into the curing liquid.

“Curing” means altering the chemical composition of a compound. In some cases the curing module 140 causes the solid composition 125 to have an increase in a desirable property compared with the composition before curing, such as due to a change in crystal structure. For instance, in some cases the solid composition 125 includes calcium carbonate (CaCO₃), e.g., when the cation source used in the method is Ca²⁺ ions. Calcium carbonate has numerous known polymorphs, including amorphous calcium carbonate, aragonite, calcite, and vaterite. In some cases, the cured solid composition 150 has a crystalline structure, i.e., it is not amorphous. In some cases, the cured solid composition 150 comprises calcium carbonate in the form of aragonite, calcite, or a combination thereof.

In other embodiments, the curing happens because the curing liquid 145 changes the pH of the initial CO₂ sequestering solid composition 110. In other words, the curing liquid 145 can have a pH that causes the protonation or deprotonation of compounds within the initial CO₂ sequestering solid composition 110. In some cases, the curing process happens because some solid compounds of the initial CO₂ sequestering solid composition 110 become dissolved in the curing liquid 145, thereby separating them from the sequestering solid. The curing liquid 145 can also contain compounds that transition from being dissolved in the curing liquid 145 to the solid state, thereby becoming part of the sequestering solid.

The curing liquid 145 can also be described by the molar ratio of alkali metal ions, such as Na⁺, and ammonium ions to dissolved inorganic carbon, such as HCO₃ and CO₃²⁻. For example, if the curing liquid 145 has 1 M sodium carbonate, then the concentration of sodium ions is 2 M and the concentration of carbonate ions is 1 M, giving a molar ratio of 2. In a different example, if the curing liquid 145 has 1 M of sodium bicarbonate then the concentration of sodium ions is 1 M and the concentration of bicarbonate is 1 M, giving a molar ratio of 1. In addition, in some cases the curing liquid 145 has a combination of carbonate and bicarbonate compounds, e.g., 1 M of sodium bicarbonate and 1 M sodium carbonate. In such a case, the curing liquid 145 has 3 M of sodium ions and 2 M of dissolved inorganic carbon, giving a molar ratio of 1.5. Hence, in some cases the molar ratio of alkali metal cations and ammonium ions to dissolved inorganic carbon ranges from 1 to 3, such as from 1.25 to 2.75, from 1.5 to 2.5, or from 1.75 to 2.25. Molar ratios above 2 can be caused by addition of a non-dissolved inorganic carbon compound. For instance, 1 M sodium carbonate and 1 M of potassium hydroxide (KOH) will result in a ratio of 3 for the molar ratio of alkali metal ions to dissolved inorganic carbon.

In some cases, the curing liquid 145 comprises a carbonate curing liquid, i.e., the liquid includes a carbonate compound having the carbonate ion (CO₃²⁻), a bicarbonate compound including the bicarbonate ion (HC₃²⁻), or both. In some cases the carbonate compound has the formula M₂CO₃, wherein M is a monovalent positive ion, e.g., an alkali metal cation. For example, the carbonate compound can be sodium carbonate (Na₂CO₃), ammonium carbonate ((NH₄)₂CO₃), or potassium carbonate (K₂CO₃). In some cases, the curing liquid 145 includes a bicarbonate compound, e.g., of the formula MHCO₃, wherein M is a monovalent position ion, e.g., an alkali metal cation. Example bicarbonate compounds include sodium bicarbonate (NaHCO₃), ammonium bicarbonate (NH₄HCO₃), and potassium bicarbonate (K₂CO₃).

In some instances, the curing liquid 145 is a phosphate curing liquid, i.e., it can include a phosphate compound. As used herein, “phosphate” refers to a compound that includes four oxygen atoms bonded to a phosphorous atom, i.e., a compound that includes a phosphate group. In some cases the phosphate compound has the formula PO₄R¹R²R³, wherein R¹, R², and R³ are each independently hydrogen or a negative charge. When R¹, R², and R³ are all a hydrogen atom then the compound is H₃PO₄, which is referred to as phosphoric acid herein. When R¹ and R² are hydrogen and R³ is a negative charge, the resulting compound is H₂PO₄⁻, which is referred to herein as the dihydrogen phosphate ion, and the curing liquid has a corresponding positive ion, such as an alkali metal cation, e.g., Na⁺ or K⁺ When R¹ is hydrogen and R² and R³ are negative charges, the resulting compound is HPO₄²⁻, which is referred to herein as the hydrogen phosphate ion, and the curing liquid has corresponding positive ion or ions. When R¹, R², and R³ are all negative charges then the compound is P₄³⁻, which is referred to herein as the phosphate ion, and the curing liquid has corresponding positive ion or ions. The phosphate curing liquid can also include a polyphosphate group, i.e., a group having two or more phosphorous atoms which are each bonded to four oxygen atoms, wherein one of the oxygen atoms is bonded to two phosphorous atoms. An exemplary polyphosphate compound is polyphosphoric acid, which has the formula HO—(PO₀H)ₙ—H, wherein n is an integer of 2 or more, such as from 2 to 10,000. In some cases, the polyphosphate is deprotonated, i.e., wherein one or more of the hydrogen atoms are replaced with negative charges, and the curing liquid 145 includes corresponding positive ions, e.g., alkali metal cations such as Na⁺ and K⁺. In some cases, the phosphate compound is an organophosphate compound, i.e., has the formula PO₄R¹R²R³, wherein R¹, R², and R³ are each independently hydrogen, a hydrocarbon group, or negative charge, wherein at least one of R¹, R², and R³ is a hydrocarbon group.

In some cases, the curing liquid 145 is a divalent alkali earth metal, e.g., calcium, magnesium, etc., curing liquid, such as a calcium curing liquid, i.e., it can include divalent alkalie earth metal ions, e.g., calcium ions (Ca²⁺) magnesium ions (Mg²⁺), etc. In some instances, the divalent alkali earth metal, e.g., calcium, curing liquid has a divalent alkali earth metal, e.g., calcium, ion concentration ranging from 0.01 M to 1.0 M, such as from 0.02 M to 0.2 M, or 0.09 M to 0.9 M. Such curing liquids may vary, as desired, so long as they provide a source of divalent alkali earth ion, where examples of such curing liquids include, but are not limited to, CaCl₂, MgCl₂, etc. In some cases where the curing liquid 145 is a calcium curing liquid, the calcium curing liquid is supersaturated with Ca²⁺ and DIC, wherein additional CO₂ sequestering solid 110 is formed.

In some cases, the curing liquid 145 includes tap water, i.e., the curing liquid includes water obtained from a municipal water supply. The term “municipal water supply” refers to potable water (i.e., drinking water) that is regarded as safe for humans to drink and that is delivered by pipes to two or more businesses or homes, such as 100 or more businesses or homes. For example, the municipal water supply can obtain water from a body of water, such as a lake or river, optionally treat the water, and then direct it through pipes to the homes and businesses. The water is sometimes treated to kill microorganisms, remove solid particulates, add compounds that inhibit corrosion of pipes, add compounds that inhibit tooth decay in humans who drink the water, or a combination thereof. The curing liquid 145 can include exclusively tap water, or the curing liquid can include tap water mixed with other compounds, e.g., the bicarbonate compounds, carbonate compounds, or phosphate compounds described above, or combinations thereof. In some cases the tap water has a salinity, i.e., the amount of salts dissolved in the water, ranging from 0 part per thousand (ppt) to 5 ppt (mass per volume), such as from 0 ppt to 2 ppt, or from 0 ppt to 1 ppt. In some cases, the tap water meets the requirements for acceptable drinking water established by a government having jurisdiction over distribution of the tap water. For instance, in the United States the Environmental Protection Agency (EPA) has published the National Primary Drinking Water Regulations, which describes the maximum acceptable level of approximately 90 contaminants. For example, the 2016 edition of this Regulation sets a Maximum Contaminant Level (MCL) of 0.005 mg/L for benzene, 4.0 mg/L for fluoride, 4 millirems per year for “beta photon emitters”, and 0.005 mg/L for cadmium. As another example, the European Union published the Drinking Water Directive (Directive 98/83/EC) in 1998, which describes maximum permitted levels of various contaminants, such as 0.001 mg/L for benzene and 1.5 mg/L for fluoride.

In some cases, the curing liquid 145 comprises a combination of any of the abovementioned curing liquids, i.e., a composite curing liquid comprised of bicarbonate curing liquid, carbonate curing liquid, phosphate curing liquid, alkali earth metal, e.g., calcium, curing liquid and tap water, or any composite combination thereof.

In some cases the pH of the curing liquid 145 influences the curing process. In other words, the curing liquid 145 can have a pH that causes the protonation or deprotonation of compounds within the initial CO₂ sequestering solid composition. In some cases, the pH of the curing liquid 145 is raised by addition of an alkali metal hydroxide, such as sodium hydroxide or potassium hydroxide, an alkali earth metal hydroxide, such as calcium hydroxide or magnesium hydroxide, or a combination thereof. In some cases the curing liquid 145 has a pH ranging from 5 to 14, such as from 6 to 14, from 7 to 14, from 8 to 14, from 9 to 14, or from 10 to 14.

In some embodiments, the curing module 140 includes a chamber (not shown), such as a bubble or a bag, in order to maintain a certain amount of humidity so as to prevent the the solid composition 125 from drying out.

The curing module 140 may contact the solid composition 125 with the curing liquid 145 using any convenient protocol. For example, one of the elements can be stationary while the other element is moved into proximity with the first element. For instance, the curing module 140 may include a reservoir in which the curing liquid 145 can be located such that the solid composition 125 can be placed into the reservoir so that it is submerged in the curing liquid 145. Accordingly, some or all of the solid composition 125 is located below a top surface of the curing liquid 145. The solid composition 125 can remain submerged in the curing liquid 145 for any suitable period of time, such as between 1 minute and 30 days, between 1 hour and 10 days, and 12 hours and 5 days. As another example, the solid composition 125 can be stationary and the curing liquid 145 can be sprayed onto it, i.e., the curing liquid 145 can be moved so that it contacts a surface of the solid composition 125. In some cases, the spraying includes moving the curing liquid 145 through one or more openings such that it forms two or more discrete droplets of curing liquid before contacting the surface of the solid composition 125. Directing the curing liquid 145 through the one or more openings can include exerting a mechanical force on the curing liquid 145, e.g., via a pump, it can include a gravitational force pushing the curing liquid 145 through the one or more openings, or both. After the curing liquid 145 is sprayed onto the solid composition 125, the curing liquid 145 can continue to move so that it is no longer in contact with the solid composition 125, e.g., if solid composition 125 is located on a filtration membrane and a suction force is being applied that moves the curing liquid 145 through the filtration membrane, or the curing liquid 145 can stop moving and remain in contact with the solid composition 125 for a suitable period of time, such as between 1 minute and 30 days, between 1 hour and 10 days, and 12 hours and 5 days. In some cases, the contacting includes moving both the curing liquid 145 and the solid composition 125 are moving when they contact one another. For instance, the solid composition 125 can be positioned on a moving surface, e.g., on a conveyor belt, and the moving surface can move the aggregate 135 into a location where the curing liquid 145 is moving, e.g., through an opening of a sprayer, thereby causing the solid composition 125 and the curing liquid 145 to contact one another. In some embodiments, the curing liquid 145 is recycled after contacting the solid composition 125 on the moving surface so that it can contact a second solid composition. In some cases the curing liquid 145 is at a temperature ranging from 5° C. to 80° C., e.g., 5° C. to 60° C., such as 10° C. to 50° C., e.g., 17° C. to 50° C., e.g., 20° C. to 50°, for at least a portion of the contacting, e.g., for the entire time of the contacting.

The cured solid composition 150 can provide for long-term storage of CO₂ in a manner such that CO₂ is sequestered (i.e., fixed) in the material, wherein the sequestered CO₂ does not become part of the atmosphere. When the cured aggregate 150 is maintained under conditions convention for its intended use, the solid keeps sequestered CO₂ fixed for extended periods of time, such as 1 year or longer, 5 years or longer, 10 years or longer, 25 years or longer, or 50 years or longer, with significant, if any, release of CO₂ from the solid. For instance, when the cured aggregate 150 is maintained in a manner consistent with its intended use, the amount of CO₂ gas released from the solid is 10% or less of the total amount of CO₂ in the solid per year, such as 5% or less or 1% or less when exposed to normal conditions of temperature and moisture, including rainfall of normal pH, for there intended use, for at least 1, 2, 5, 10, or 20 years, or for more than 20 years, for example, for more than 100 years. Any suitable surrogate marker or test that is reasonably able to predict such stability may be used. For example, an accelerated test comprising conditions of elevated temperature and/or moderate to more extreme pH conditions is reasonably able to indicate stability over extended periods of time. For example, depending on the intended use and environment of the solid, a sample of the cured CO₂ sequestering solid may be exposed to 50, 75, 90, 100, 120, or 150° C. for 1, 2, 5, 25, 50, 100, 200, or 500 days at between 10% and 50% relative humidity, and a loss less than 1%, 2%, 3%, 4%, 5%, 10%, 20%, 30%, or 50% of its carbon may be considered sufficient evidence of stability of the solid for a given period (e.g., 1, 10, 100, 1000, or more than 1000 years).

In some cases, the curing results in changing a compound of the initial CO₂ sequestering composition 110 from a first crystal structure to a second crystal structure, wherein the curing compound permits or increases the rate of this change. In some cases, the curing results in a carbonate compound changing from a first crystal structure in the initial CO₂ sequestering solid composition 110 to a second crystal structure in the cured CO₂ sequestering aggregate 150. For instance, in some cases the first crystal structure is vaterite or amorphous calcium carbonate, and the second crystal structure is aragonite or calcite. In some cases, the cured CO₂ sequestering solid composition 150 has a crystalline structure, i.e., it is not amorphous.

In some cases, the cured CO₂ sequestering solid composition 150 has different properties than the initial CO₂ sequestering solid composition 110. For instance, the cured CO₂ sequestering solid composition 150 may have a greater resistance to fracturing than the initial CO₂ sequestering solid composition 110. For example, this increased resistance to fracturing can be caused by a change in crystal structure. Resistance to fracturing can be described in various manners. For instance, in some cases the resistance to fracturing is resistance of a single piece of material to break into multiple pieces upon mechanical agitation. In some cases, the resistance to fracturing is resistance of a single piece of material to break into multiple pieces upon being compressed by an external force. In some embodiments, the cured CO₂ sequestering solid composition 150 has a Mohs scratch hardness of 2 or greater according to the Mohs Hardness Scale. In some cases, concrete specimens containing the cured CO₂ sequestering solid composition have average 28-day compressive strength and calculated equilibrium density ranging from 2,500 psi to 4,000 psi and 100 lb/ft to 115 lb/ft³, respectively, according to ASTM C330.

As an example, to perform a durability test of the finished aggregates, the dried aggregates can be placed into a sieve shaker with granite rocks to provide abrasion. For example, approximately 6 g of the aggregates (3 granules) can be placed in a sieve with 155.0 g of granite rocks. Identical sets of granite rocks can be used for every durability test. In some tests, the durable aggregates were found to have less than 4.0% weight loss.

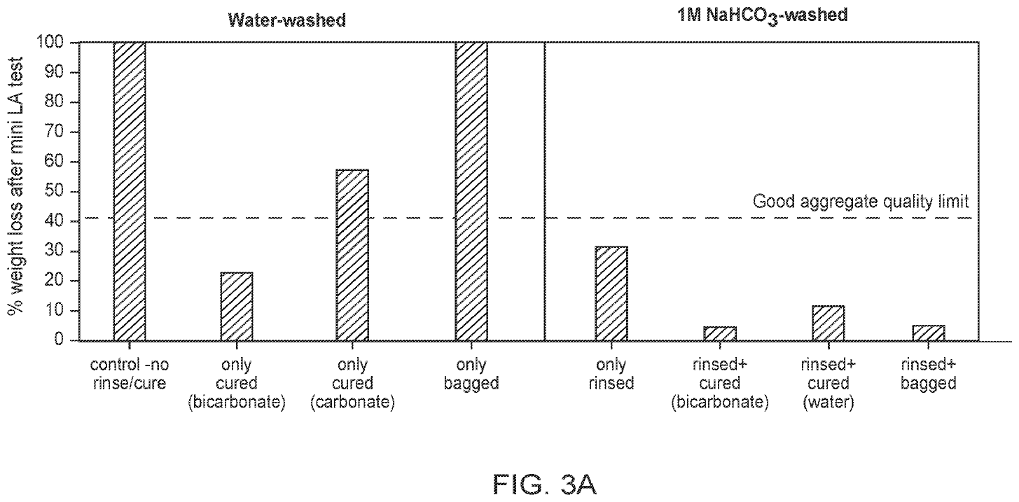

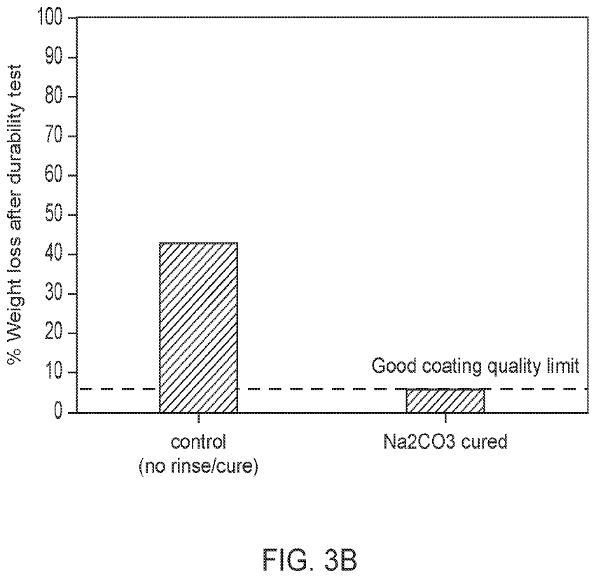

As an example, FIG. 3B illustrates the results of a durability test. As depicted, curing causes a reduction in average weight loss after durability test, such that durability of 1-month aggregate cured in warm 1M Na₂CO₃ is far superior as compared to not cured aggregates.

The effect of spraying the curing liquid onto the aggregates at different temperatures is one embodiment of the invention. Without spraying any curing liquid, the aggregates had a mass loss during durability testing of about 10%, whereas the mass loss when sprayed with 1 M sodium carbonate at 25° C. and 40° C. was about 6% in both cases. Hence, it appears that spraying increased the durability, but spraying at 25° C. or 40° C. resulted in about equal increases in durability. In other words, the temperature difference of 25° C. compared with 40° C. did not appear to influence the durability of the aggregates.

System 100 may optionally include a wash station 160 for treating the cured solid composition 150 to remove one or more ions/compounds associated therewith and to generate washed cured CO₂ sequestering solid composition 170. For example, the wash station 160 may be used to wash the cured CO₂ sequestering solid composition 150 to remove one or more compounds associated therewith, e.g., compounds or ions, using a rinse liquid 165. For example, where a given production protocol results in the presence of chloride ions or compounds, the cured solid may be washed to remove the chloride ions or compounds. Likewise, where a given production protocol results in the presence of ammonia ions/compounds, the cured solid composition 150 may be washed to remove such ions/compounds. In some embodiments, wash station 160 is the same as rinse station 120, e.g., depending on type of liquids used.

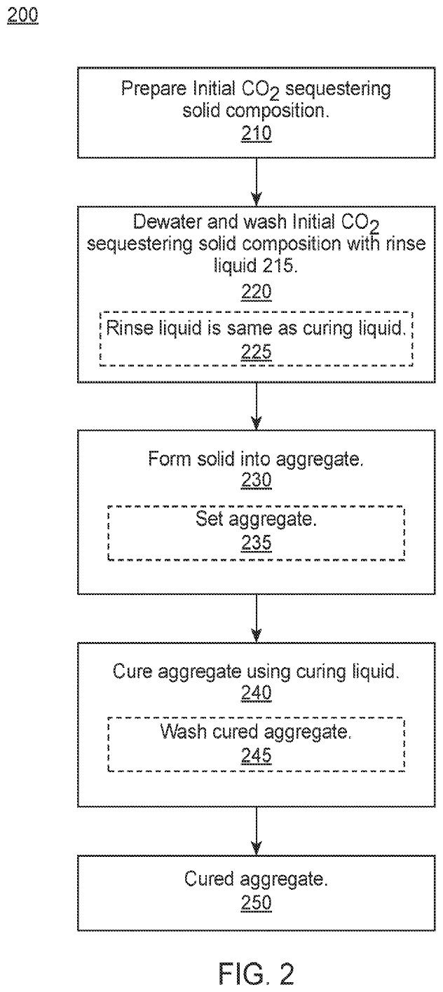

FIG. 2 depicts an embodiment of a method 200 of operation of system 100 to generate durable CaCO₃ aggregates and sand by curing aggregates from CO₂ gas absorption process. Method 200 starts at block 210 where module 105 prepares the initial CO₂ sequestering solid composition 110 as an aggregate or coated aggregate. At block 220, the initial CO₂ sequestering aggregate or coated aggregates composition are dewatered and washed with a suitable rinse liquid 115 at rinse station 120 to produce washed aggregate 125. In some embodiments, at 225, optionally the rinse liquid is the same as the curing liquid. As an example, precipitated CaCO₃ slurry is washed with water 1 to 5 times. In some samples, the slurry is mixed with mixing solutions and dewatered. The mixing solutions can be used as one solution or in combinations of Na₂CO₃, NaHCO₃, SrCl₂, MgCl₂, Na-silicate, silica gel, NaH₂PO₃, Na₂HPO₃, and Na₃PO₄ solutions. As the result, the dewatered wet CaCO₃ cake with roughly 50-80% solid content is generated. The slurry can be used to make the following products: pure CaCO₃ coarse aggregates and CaCO₃-coated aggregates (coarse or fine). At block 230, the CaCO₃ slurry is formed into aggregate. As an example, the CaCO₃ slurry with 50-80% solid content is placed into a rotating drum for 15-40 min for further compaction and for drying and maturation of unstable CaCO₃ phases. The slurry will agglomerate to form aggregates.

In some embodiments, the method further includes optionally setting the aggregate, if damp, at block 235. As discussed above, the initial CO₂ sequestering solid composition 110 can include not only compounds in the solid state, but also compounds in a liquid state, e.g., liquid water. “Setting” is used interchangeably with “air drying” and includes placing the washed aggregate 125 in an environment such that there is evaporation of liquid from the solid composition. By removing a liquid from the solid composition, the chemical composition and thereby physical properties of the solid composition can be altered, e.g., a reduced volume of liquid can cause solutes dissolved in the liquid to transition to a solid state. For example, the washed aggregate 125 can be placed on a solid surface so that it is not in contact with another liquid, e.g., so that liquid from the solid composition can evaporate and the solid composition will not gain liquid from another liquid. In some cases the step 220 includes ways of increasing the rate of evaporation, e.g., flowing a gas past the solid composition, applying a reduced gas pressure to the solid composition, increasing the temperature of the solid composition, or a combination thereof. Flowing the gas past the solid composition can be performed, for example, with a fan. A pump, e.g., a vacuum pump, can be employed to reduce the gas pressure, thereby increasing the rate of evaporation. The temperature of the washed aggregage 125 can be increased, e.g., using an electric heater or a natural gas heater, to a temperature such as ranging from 25° C. to 95° C., such as from 35° C. to 80° C. In embodiments, the setting can be done simply by air drying for 1-30 days or by drying with elevated temperature (for minutes-hours at 30-200° C.). As example, the aggregates can be set by leaving in the open air, or by containing in a moist environment for few hours. The process can be expedited by applying heat for 10 min-2 hours, depending on the temperature.

Setting time affects the curing of the CO₂ sequestering aggregate. As discussed, in block 220, the aggregates can be allowed to “set” for a period of time before the curing step 230. In one embodiment, the CO₂ sequestering aggregates were allowed to “set” by remaining in room temperature air for 1 day, 3 days, or 7 days, and then cured by being submerged in 1 M sodium carbonate. Without setting, the mass loss during durability testing was about 21%, whereas that amount decreased to about 15% upon letting the aggregates set for about 1 day before curing. Hence, it appears that setting can increase the durability of the aggregates. Increasing the setting time to 3 days or 7 days resulted in additional decreases in mass loss during durability testing of about 6% or about 3%, respectively. Thus, it appears that increased setting time, e.g., at least up until 7 days of setting time, significantly increased durability and significantly decreased mass loss from about 21% to about 3%.

At block 240, the aggregate 135 is contacted with the curing liquid 145 at curing module 140. Contacting the aggregate 135 with the curing liquid 145 results in the production of a cured CO₂ sequestering aggregate 150. As an example, the aggregates 135 are submerged (cured) or sprayed with either of the curing solutions at 4 C-100 C: water, 0.1-1M Na₂CO₃, 0.1-1M NaHCO₃, 10 mM-1M Na₂PO₄, Na₂HPO₄, Na₂PO₄ solutions for few minutes-few months. As an example, the set aggregates can be submerged or sprayed with either of the curing solutions at 4 C-100 C: water, 0.1-1M Na₂CO₃, 0.1-1 M NaHCO₃, 10 mM-1M Na₂PO₄, Na₂HPO₄, Na₃PO₄ solutions for 30 minutes up to a few months.

At block 240, in some embodiments, the set aggregates 235 can be cured by simply slowing the rate of drying. For example, in one embodiment of the method, the set aggregates 235 are cured to form cured aggregates 250 by placement in an enclosed space or cavity with control of temperature and humidity. In some instances the set aggregates 235 are exposed to a temperature controlled environment whereby the humidity consists of rinse liquid 115 in the enclosed space or cavity. In other instances, the set aggregates 235 are exposed to a temperature controlled environment whereby the humidity consists of rinse liquid 165 in the enclosed space or cavity, and yet, in other instances, the set aggregates 235 are exposed to a temperature controlled environment whereby the humidity consists of curing liquid 145 in the enclosed space or cavity. In some of the embodiments above, or in any combination of some of the embodiments above, the set aggregates 235 will yield cured aggregates 250, all of which are suitable for use as a building material, e.g., for use as aggregate in concrete.

In other embodiments at block 240, the temperature and humidity may be controlled to have a desirable relative humidity so as to slow down or increase the rate of curing of set aggregates 235 into cured aggregates 250.

At block 245, in some embodiments, the method further includes optionally treating the cured aggregate 150 to remove one or more ions/compounds associated therewith. For example, the methods may include washing the cured CO₂ sequestering aggregate 150 at wash station 160 to remove one or more compounds associated therewith, e.g., compounds or ions. For example, where a given production protocol results in the presence of chloride ions or compounds, the cured solid may be washed to remove the chloride ions or compounds. Likewise, where a given production protocol results in the presence of ammonia ions/compounds, the cured aggregate 150 may be washed to remove such ions/compounds. Washing may be achieved using any convenient protocol. For example, the cured aggregate 150 may be contacted with a wash liquid 165, e.g., tap water, under conditions sufficient to separate the desired ions/compounds (e.g., as described above) from the cured product. For example, the cured aggregate 150 may be submersed in the wash liquid 165, the wash liquid 165 may be flowed over the cured solids, the wash liquid 165 may be contacted with the cured aggregate 150 under pressure, etc. Where desired, ions/compounds removed from the cured aggregate 150 may be harvested from the wash liquid 165, e.g., for reuse. As an example, the cured aggregates are washed with water and dried in the air.

The cured CO₂ sequestering solid 150 can have various shapes and sizes. At block 245, optionally, the cured CO₂ sequestering aggregate 150 is formed into a plurality of cured formed aggregates having diameters ranging from 300 μm to 50,000 μm, such as from 1,000 μm to 10,000 μm, and can have various shapes and sizes. In some cases, the cured CO₂ sequestering aggregate 150 has a volume ranging from 0.00001 cm³ to 150 cm³, such as from 0.01 cm³ to 10 cm³. In some cases there are 2 or more pieces with such diameters or volumes, such as 5 or more pieces, 100 or more pieces, or 1,000 or more pieces. In some cases, the aggregates can have a dry loose bulk density ranging from 30 lb/ft³ to 100 lb/ft³ according to ASTM C330, such as from 50 lb/ft³ to 75 lb/ft³.

At block 250, the cured CO₂ sequestering aggregate 150 or the plurality of cured formed aggregates are ready for use as a building material, e.g., as aggregate for concrete.

FIG. 3A illustrates the effect of washing and curing CaCO₃ aggregates. The CaCO₃ aggregates made from CO₂ absorption process (low-energy process) are weak when not washed and are strengthened by washing and curing. The chart illustrated in FIG. 3A depicts comparisons between water-washed slurry samples to those washed with 1M NaHCO₃. The samples that were only cured (without bicarbonate wash), or only washed (without cure) showed lower strength relative to the one's that were both washed and cured/bagged. In addition to curing with bicarbonate solution, curing (spraying) with water or bagging (no solution sprayed) the aggregates from washed slurry have also exhibited significant effect in terms of final aggregate strength.

FIG. 3B illustrates the effect of washing and curing CaCO₃ coated aggregates. The CaCO₃-coated aggregates made from CO₂ absorption process (low-energy process) are weak when not washed or cured with desired solutions (mostly carbonate/bicarbonate solutions). The data shows comparisons between a control (not washed/cured) vs. one that was cured with Na₂CO₃. The result shows that Na₂CO₃ curing affects positively on coated sand strength as well.

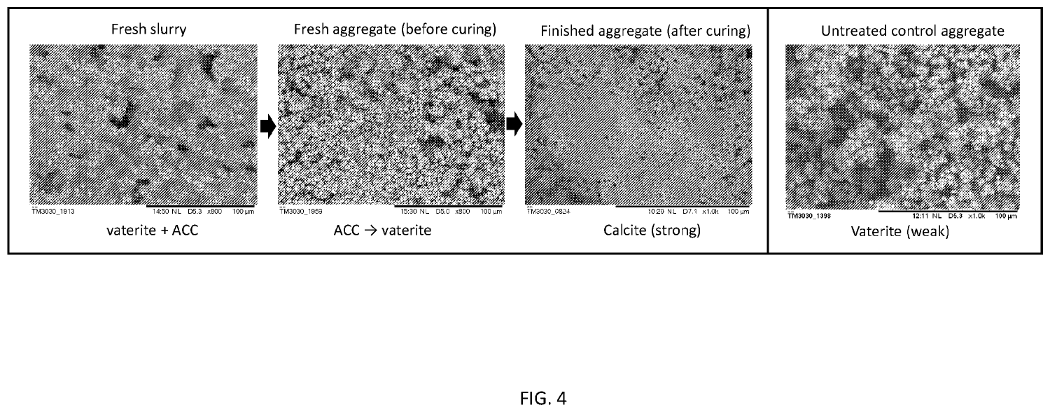

FIG. 4 illustrates scanning electron spectroscopy (SEM) images of original slurry (unwashed), washed and agglomerated aggregate, and final aggregate after curing (compared with an untreated control). As illustrated, the final cured aggregate is much stronger than the untreated control sample.

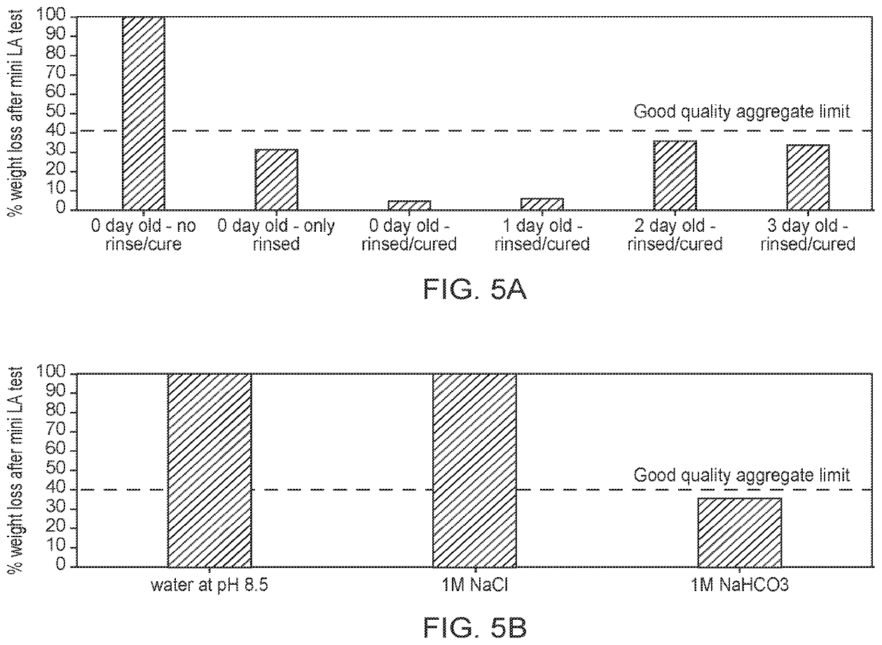

FIG. 5A illustrates the effect of washing and curing on old slurries. Normally, old slurries cannot make strong aggregates. However, as illustrated, washing alone made the old slurry much stronger, while washing and curing for 2 or 3 days has the best impact on the strength of the old slurry. FIG. 5B illustrates the effect of sodium and pH in wash solution. The chart in FIG. 5B illustrates that pH or Na do not affect the strength of the washed and cured aggregate, rather that the bicarbonate wash is the main source of strength.

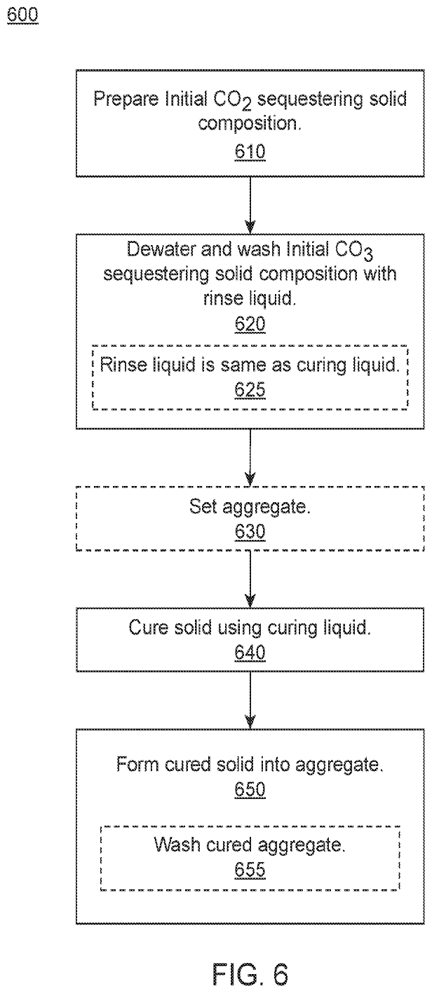

FIG. 6 depicts an embodiment of a method 600 of operation of system 100 to generate durable CaCO₃ aggregates and sand by curing slurry from CO₂ gas absorption process. Method 600 starts at block 610 where module 105 prepares the initial CO₂ sequestering solid composition 110 as CaCO₃ slurry. At block 620, the initial CO₂ sequestering CaCO₃ slurry is dewatered and washed with a suitable liquid 115 at rinse station 120 to produce washed solid composition 125. As an example, precipitated CaCO₃ slurry can be washed with water 1 to 5 times. In some samples, slurry is mixed with mixing solutions and dewatered. The mixing solutions were used as one solution or in combinations of Na₂CO₃, NaHCO₃, SrCl₂, MgCl₂, Na-silicate, silica gel, NaH₂PO₃, Na₂HPO₃, Na₃PO₄ solutions. As the result, the dewatered wet CaCO₃ cake with roughly 50-80% solid content is generated. The slurry can be used to make a variety of products, e.g., pure CaCO₃ coarse aggregates and pure CaCO₃. As an example, at 620, CaCO₃ suspension after gas absorption process can be dewatered and washed with water by vacuum filtration. Then 300 ml of 1M NaHCO₃ can be decanted on top of the slurry in Buchner funnel and filtered using vacuum filtration. As the result, 363g of CaCO₃ with 63% solid content can be generated (165 g of total CaCO₃). The dewatered slurry can be placed into a rotating drum for agglomeration. The slurry can be sprayed with water 3 times and agglomerated for 20 min with heater maintaining 22-23° C. surface temperature. The drum-rolling provided further compaction and polymorph transition of unstable CaCO₃ phases.

In some embodiments, the method further includes optionally setting the washed solid composition 125 at block 630. As discussed above, the initial CO₂ sequestering solid composition 110 can include not only compounds in the solid state, but also compounds in a liquid state, e.g., liquid water. “Setting” is used interchangeably with “air drying” and includes placing the washed aggregate 125 in an environment such that there is evaporation of liquid from the solid composition. By removing a liquid from the solid composition, the chemical composition and thereby physical properties of the solid composition can be altered, e.g., a reduced volume of liquid can cause solutes dissolved in the liquid to transition to a solid state. For example, the washed aggregate 125 can be placed on a solid surface so that it is not in contact with another liquid, e.g., so that liquid from the solid composition can evaporate and the solid composition will not gain liquid from another liquid. In some cases the step 220 includes ways of increasing the rate of evaporation, e.g., flowing a gas past the solid composition, applying a reduced gas pressure to the solid composition, increasing the temperature of the solid composition, or a combination thereof. Flowing the gas past the solid composition can be performed, for example, with a fan. A pump, e.g., a vacuum pump, can be employed to reduce the gas pressure, thereby increasing the rate of evaporation. The temperature of the washed aggregage 125 can be increased, e.g., using an electric heater or a natural gas heater, to a temperature such as ranging from 25° C. to 95° C., such as from 35° C. to 80° C. In embodiments, the setting can be done simply by air drying for 1-30 days or by drying with elevated temperature (for minutes-hours at 30-200° C.), or by placing in a plastic bag.

At block 640, the washed solid 135 is contacted with the curing liquid 145 at curing module 140. Contacting the solid 135 with the curing liquid 145 results in the production of a cured CO₂ sequestering solid composition 150. As an example, the washed solid 135 can be submerged or sprayed with either of the curing solutions at 4C-100C: water, 0.1-1M Na₂CO₃, 0.1-1M NaHCO₃, 10 mM-1M Na₃PO₄, Na₂HPO₄, Na₃ PO₄ solutions for a curing period, which can be from 30 minutes to a few months long. The curing process may include curing in a confined space (such as, a humidity chamber or container or a bag), to slow the rate of drying. As an example where the slurry is cured without agglomeration, wet slurry cake with 60-80% solid content can be submerged or sprayed (cured) with either of the curing solutions at 4C-100C: water, 0.1-1M Na₂CO₃, 0.1-1M NaHCO₃, 10 mM-1M SrCl₂, MgCl₂, Na-silicate, silica gel, NaH₂PO₃, Na₂HPO₃, Na₃PO₄for hours-few months.

The cured CO₂ sequestering solid 150 can have various shapes and sizes. At block 650, the cured CO₂ sequestering solid composition 150 is formed into a plurality of cured formed aggregates having diameters ranging from 300 μm to 50,000 μm, such as from 1,000 μm to 10,000 μm, and can have various shapes and sizes. In some cases, the cured CO₂ sequestering solid composition 150 has a volume ranging from 0.00001 cm³ to 150 cm³, such as from 0.01 cm³ to 10 cm³ . In some cases there are 2 or more pieces with such diameters or volumes, such as 5 or more pieces, 100 or more pieces, or 1,000 or more pieces. In some cases, the aggregates can have a dry loose bulk density ranging from 30 lb/ft³ to 100 lb/ft³ according to ASTM C330, such as from 50 lb/ft³ to 75 lb/ft³.

As an example, at block 650, in order to produce aggregate from slurry, a non-scraped agglomeration (NSA) process is used. The CaCO₃ slurry cake is dewatered by paper towels and compacted by a rolling pin. The compacted cake is then cut into smaller pieces and blended with dried CaCO₃ powder or waste dust fines to control the surface water and to prevent the pieces from agglomerating. The CaCO₃ pieces and powder blends are placed into a rotating drum for 3-60 min for further compaction and for drying/maturation of unstable CaCO₃ phases. The damp aggregates are taken out and placed in the air for further drying and setting for few hours to 7 days. As examples, the aggregates generated may be pure CaCO₃ coarse aggregates or CaCO₃-coated aggregates, and can be either coarse or fine.

At block 655, in some embodiments, the method further includes optionally treating the cured aggregate 150 to remove one or more ions/compounds associated therewith. For example, the methods may include washing the cured CO₂ sequestering aggregate 150 at wash station 160 using rinse liquid 165 to remove one or more compounds associated therewith, e.g., compounds or ions. For example, where a given production protocol results in the presence of chloride ions or compounds, the cured solid may be washed to remove the chloride ions or compounds. Likewise, where a given production protocol results in the presence of ammonia ions/compounds, the cured aggregate 150 may be washed to remove such ions/compounds. Washing may be achieved using any convenient protocol. For example, the cured aggregate 150 may be contacted with a wash liquid 165, e.g., tap water, under conditions sufficient to separate the desired ions/compounds (e.g., as described above) from the cured product. For example, the cured aggregate 150 may be submersed in the wash liquid 165, the wash liquid 165 may be flowed over the cured solids, the wash liquid 165 may be contacted with the cured aggregate 150 under pressure, etc. Where desired, ions/compounds removed from the cured aggregate 150 may be harvested from the wash liquid 165, e.g., for reuse. For example, at 655, the finished aggregates are washed with a wash liquid, such as water, and dried, such as air-dried.

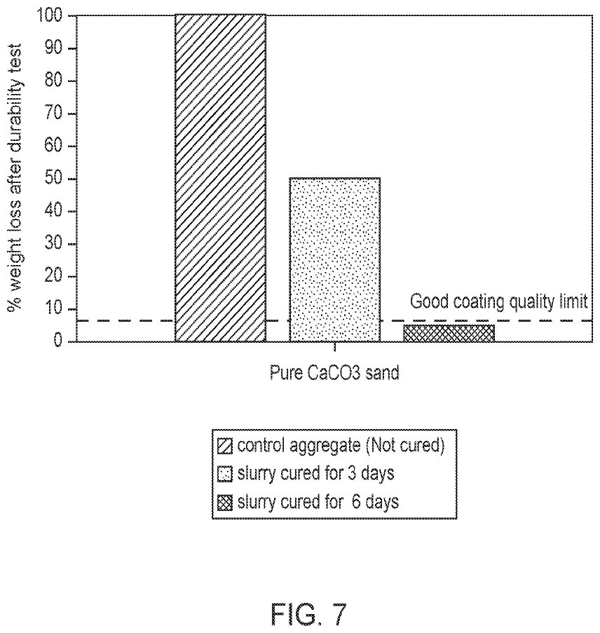

FIG. 7 illustrates the strength of aggregates made from slurry curing, where the slurry is cured without agglomeration. As depicted in FIG. 7, the control aggregate (not cured) is weaker than and slurries that were cured for 3 and 6 days, with the slurry that was cured for 6 days showing significant increase in strength.

### Steam Treatment of CO₂ Sequestering Solids

The inventors have realized that green cement/concrete compositions may include one or more impurities, e.g., resulting from fabrication protocols, that negatively impact the functionality of the compositions. As described below, the inventors have identified ways to address this problem. As such, embodiments of the invention may include separating an impurity from a CO₂ sequestering solid, e.g., prepared as described above. In such embodiments, aspects of the methods include contacting a CO₂ sequestering solid, which solid may or may not be a solid prepared by a curing process, such as describe above, with steam in a manner sufficient to remove an impurity from the CO₂ sequestering solid. aspects of the invention include methods of separating an impurity from a CO₂ sequestering solid. By separating an impurity is meant removing the impurity from the CO₂ sequestering solid such that the solid no longer includes the impurity or contains the impurity or otherwise has the impurity associated with it in any way. A given method may remove a single impurity or two or more distinct impurities, such as three or more, four or more, five or more, ten or more, twenty or more, etc.

Impurities that may be removed from a given solid by methods of the invention may vary. Impurities that may be removed include compounds, elements, ions, etc. Examples of impurities that may be removed include, but are not limited to, ammonia, ammonium, chlorine, chloride anion, sodium, magnesium, calcium, bicarbonate ion and the like. In some instances, the impurity is a mediator of a CO₂ sequestering solid production method, e.g., as described in greater detail below, where examples of these types of impurities include, but are not limited to, ammonia, ammonium or a combination thereof. In some instances, the impurity is a byproduct of a CO₂ sequestering solid production method, e.g., as described in greater detail below, where examples of these types of impurities include, but are not limited to, salts or ions thereof, e.g., chloride ion. Because methods of the invention separate one or more impurities from a CO₂ sequestering solid, CO₂ sequestering solids treated in accordance with the methods have a reduced mass following treatment as compared to prior to treatment. While the magnitude of mass reduction may vary, in some instances the magnitude of mass reduction ranges from 0.1% to 10%, such as 0.5% to 5%.

In practicing embodiments of the invention, a CO₂ sequestering solid is contacted with steam in a manner sufficient to remove the one or more impurities from the CO₂ sequestering solid. The term “steam” is employed in its conventional sense to refer to water in the gas phase. The steam that is contacted with the solid may be wet steam or saturated/superheated steam. In some instances, the steam has a heat of vaporization of 970 Btu/lb or lower, such as 910 Btu/lb or lower, including 880 Btu/lb or lower. The solid may be contacted with steam using any convenient protocol. In some instances, steam is flowed across one or more surfaces of the solid. The flow rate of the steam across the solid surface(s) may vary, and in some instances ranges from 1 lb/hr to 100 lb/hr, such as 5 lb/hr to 75 lb/hr.

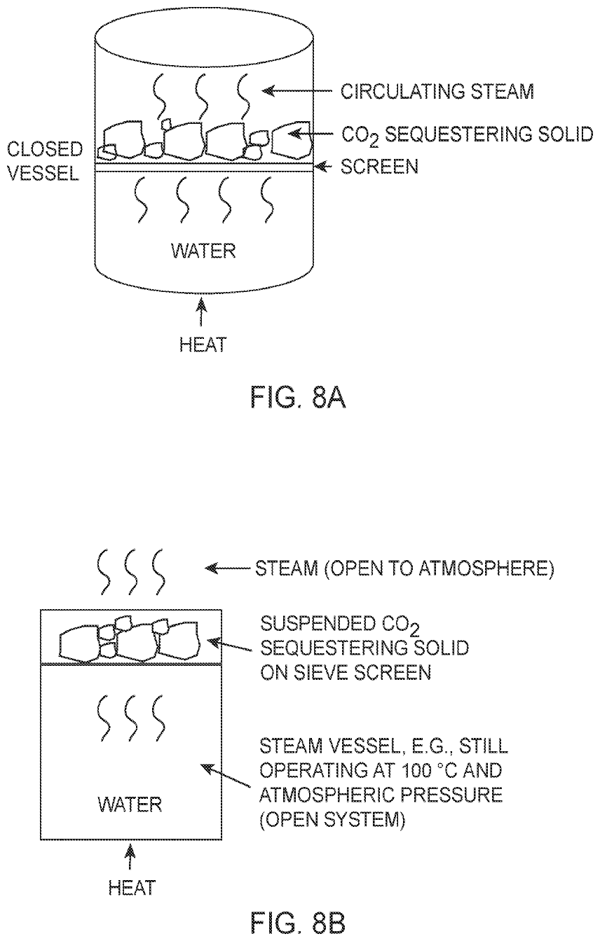

The steam may be contacted with the solid in any convenient type of system. In some instances, the system employed to contact the steam with the solid is a closed system, e.g., where the steam and solid are inaccessible by the external environment (e.g., a system in which mass or energy cannot be lost to or gained from the environment). In such instances, the pressure in the closed system may vary, and may be greater than atmospheric pressure, ranging in some instances from 1 to 100 psig, such as 3 to 15 psig. The temperature of the steam in such systems may also vary, ranging in some instances from 100 to 170, such as 105 to 120° C. FIG. 8A provides an illustration of closed system. As shown in FIG. 8A, aggregate is held on a mesh screen over boiling water in a sealed container in which the pressure is greater than atmospheric pressure. Steam rising from the water flows up past the aggregate, circulating around the aggregate on its surface and in into the pores of the aggregate, thereby treating the aggregate to remove impurities, e.g., ammonium, ammonium salt and combinations thereof.

In some instances, the system is an open system, e.g., where the steam and solid are accessible by the external environment (e.g., a system in which mass or energy can be lost to or gained from the environment). In open systems, the steam that is contacted with the solid at atmospheric pressure, e.g., 0 psig, and may have a temperature of 100° C. FIG. 8B provides an illustration of an open system. As shown in FIG. 8B, CO₂ sequestering aggregate is suspended in sieve screen (although other types of suspension may be employed, e.g., a mesh bag) over water maintained at 100° C., such that steam generated flows up past the aggregate, and into the surface pores of the aggregate, thereby treating the aggregate to remove impurities, e.g., ammonium, ammonium salt and combinations thereof.

In one embodiment, CO₂ sequestering solid aggregate is contacted with steam in a closed system, i.e., the closed steam treatment system illustrated in FIG. 8A, at a contact pressure greater than atmospheric pressure, ranging from roughly 4.3 psig to 12 psig, and temperature ranging from approximately 107° C. to 118° C., for a time period of between 10 min and 60 min. The impurity in the CO₂ sequestering solid aggregate comprises a combination of ammonium, calcium and chloride, byproducts of the method used to prepare the CO₂ sequestering solid aggregate. To validate the separation of the impurity from the CO₂ sequestering solid aggregate, the steam treated aggregate is subjected to an ammonia test, whereby the steam treated aggregate is submerged in 1 M NaOH for five minutes to convert any residual ammonium to ammonia, which is then quantified using an ammonia sensor. For the steam treated aggregate to pass the ammonia test, in some instances it reaches a value of less than 25 ppm ammonia. TABLE 1 summarizes the data collected from this embodiment.

TABLE 1

| MASS OF WET | | VOLUME | PRESSURE | TEMPERATURE | TIME IN | AMMONIA |
|---|---|---|---|---|---|---|
| AGGREGATE | | OF WATER | IN CLOSED | IN CLOSED | CLOSED | TEST |
| IN CLOSED | WATER | IN CLOSED | VESSEL | VESSEL | VESSEL | RESULT |
| VESSEL (kg) | WASHES ^{a} | VESSEL (L) | (psig) | (° C.) | (min) | (ppm NH₃) |
| 1.0 ^{b} | 5 | — | — | — | — | <18 |
| 0.7 | 1 | 0.7 | 12 | 118 | 10 | <80 |
| 0.7 | 2 | 0.7 | 12 | 118 | 10 | <36 |
| 0.7 | 3 | 0.7 | 12 | 118 | 10 | <15 |
| 0.7 | 3 | 0.7 | 7.2 | 111 | 10 | <50 |
| 0.7 | 3 | 0.7 | 7.2 | 111 | 15 | <47 |
| 0.7 | 3 | 0.7 | 7.2 | 111 | 40 | <19 |
| 0.7 | 3 | 0.7 | <4.3 | 107 | 10 | <72 |
| 0.7 | 3 | 0.7 | <4.3 | 107 | 35 | <52 |
| 0.7 | 3 | 0.7 | <4.3 | 107 | 60 | <24 |

^{a} Number of 1 L washes that the CO₂ sequestering solid slurry was subjected to prior to its formation into an aggregate, i.e., the CO₂ sequestering solid composition preparation module.
^{b} CO₂ sequestering solid aggregate not subjected to steam treatment; in this embodiment, CO₂ sequestering solid aggregate is cured for at least 12 hours prior to being able to perform the ammonia test. In other embodiments that use steam treatment, the CO₂ sequestering solid aggregate can undergo the ammonia test immediately after steam treatment.

With respect to the above steam treatment embodiments, the invention is not limited to use of steam treatment with just the cured CO₂ sequestering solids prepared as described above. Instead, the steam treatment may be employed with any CO₂ sequestering solid. Examples of CO₂ sequences solids that may steam treated in accordance with embodiments of the invention include, but are not limited to, those described in U.S. Pat. Nos. 9,707,513; 9,714,406; 9,993,799; 10,197,747; 10,203,434; 10,287,439; 10,322,371; 10,711,236; 10,766,015; 10,898,854; 10,960,350; and 11,154,813; the disclosures of which are herein incorporated by reference. CO₂ sequestering solids that may be treated with steam in accordance with embodiments of the invention also include those prepared by alkaline intensive protocols, in which a CO₂ containing gas is contacted with an aqueous medium at pH of about 10 or more. Examples of such protocols include, but are not limited to, those described in U.S. Pat. Nos. 8,333,944; 8,177,909; 8,137,455; 8,114,214; 8,062,418; 8,006,446; 7,939,336; 7,931,809; 7,922,809; 7,914,685; 7,906,028; 7,887,694; 7,829,053; 7,815,880; 7,771,684; 7,753,618; 7,749,476; 7,744,761; and 7,735,274; the disclosures of which are herein incorporated by reference. Further details regarding steam treatment are provided in U.S. provisional application Ser. No. 63/128,483; the disclosure of which is herein incorporated by reference.

### Settable Compositions

In some instances, the cured CO₂ sequestering solid 150 is employed in a settable composition. Settable compositions of the invention, such as concretes and mortars, are produced by combining a hydraulic cement with an amount of cured CO₂ sequestering solid, e.g., aggregate (fine for mortar, e.g., sand; coarse with or without fine for concrete) and an aqueous liquid, e.g., water, either at the same time or by pre-combining the cement with aggregate, and then combining the resultant dry components with water. The choice of coarse aggregate material for concrete mixes using cement compositions of the invention may have a minimum size of about 0.05 inches (16-sieve size) and can vary in size from that minimum up to one inch or larger, including in gradations between these limits, where in some instances the coarse aggregates range in size from 0.0117 inches (300 microns, No. 50-sieve size) to 4 inches (100 mm). Finely divided aggregate is smaller than ⅜ inch in size and again may be graduated in much finer sizes down to 200-sieve size or so, wherein in some instance fine aggregates range in size from 0.0029 inches (75 microns, No. 200-sieve) to 0.375 inches (9.5 mm). Fine aggregates may be present in both mortars and concretes of the invention. The weight ratio of cement to aggregate in the dry components of the cement may vary, and in certain embodiments ranges from 1:10 to 4:10, such as 2:10 to 5:10 and including from 55:1000 to 70:100.

The liquid phase, e.g., aqueous fluid, with which the dry component is combined to produce the settable composition, e.g., concrete, may vary, from pure water to water that includes one or more solutes, additives, co-solvents, etc., as desired. The ratio of dry component to liquid phase that is combined in preparing the settable composition may vary, and in certain embodiments ranges from 2:10 to 7:10, such as 3:10 to 6:10 and including 4:10 to 6:10.

In certain embodiments, the cements may be employed with one or more admixtures. Admixtures are compositions added to concrete to provide it with desirable characteristics that are not obtainable with basic concrete mixtures or to modify properties of the concrete to make it more readily useable or more suitable for a particular purpose or for cost reduction. As is known in the art, an admixture is any material or composition, other than the hydraulic cement, aggregate and water, that is used as a component of the concrete or mortar to enhance some characteristic, or lower the cost, thereof. The amount of admixture that is employed may vary depending on the nature of the admixture. In certain embodiments the amounts of these components range from 1 to 50% w/w, such as 2 to 10% w/w.

Admixtures of interest include finely divided mineral admixtures such as cementitious materials; pozzolans; pozzolanic and cementitious materials; and nominally inert materials. Pozzolans include diatomaceous earth, opaline cherts, clays, shales, fly ash, silica fume, volcanic tuffs and pumicites are some of the known pozzolans. Certain ground granulated blast-furnace slags and high calcium fly ashes possess both pozzolanic and cementitious properties. Nominally inert materials can also include finely divided raw quartz, dolomites, limestone, marble, granite, and others. Fly ash is defined in ASTM C618.

Other types of admixture of interest include plasticizers, accelerators, retarders, air-entrainers, foaming agents, water reducers, corrosion inhibitors, and pigments.

As such, admixtures of interest include, but are not limited to: set accelerators, set retarders, air-entraining agents, defoamers, alkali-reactivity reducers, bonding admixtures, dispersants, coloring admixtures, corrosion inhibitors, dampproofing admixtures, gas formers, permeability reducers, pumping aids, shrinkage compensation admixtures, fungicidal admixtures, germicidal admixtures, insecticidal admixtures, rheology modifying agents, finely divided mineral admixtures, pozzolans, aggregates, wetting agents, strength enhancing agents, water repellents, and any other concrete or mortar admixture or additive. Admixtures are well-known in the art and any suitable admixture of the above type or any other desired type may be used; see, e.g., U.S. Pat. No. 7,735,274, incorporated herein by reference in its entirety.

In some instances, the settable composition is produced using an amount of a bicarbonate rich product (BRP) admixture, which may be liquid or solid form, e.g., as described in U.S. Pat. No. 9,714,406; the disclosure of which is herein incorporated by reference.

In certain embodiments, settable compositions of the invention include a cement employed with fibers, e.g., where one desires fiber-reinforced concrete. Fibers can be made of zirconia containing materials, steel, carbon, fiberglass, or synthetic materials, e.g., polypropylene, nylon, polyethylene, polyester, rayon, high-strength aramid, (i.e. Kevlar®.), or mixtures thereof.

The components of the settable composition can be combined using any convenient protocol. Each material may be mixed at the time of work, or part of or all of the materials may be mixed in advance. Alternatively, some of the materials are mixed with water with or without admixtures, such as high-range water-reducing admixtures, and then the remaining materials may be mixed therewith. As a mixing apparatus, any conventional apparatus can be used. For example, Hobart mixer, slant cylinder mixer, Omni Mixer, Henschel mixer, V-type mixer, and Nauta mixer can be employed.

Following the combination of the components to produce a settable composition (e.g., concrete), the settable compositions are in some instances initially flowable compositions, and then set after a given period of time. The setting time may vary, and in certain embodiments ranges from 30 minutes to 48 hours, such as 30 minutes to 24 hours and including from 1 hour to 4 hours.

The strength of the set product may also vary. In certain embodiments, the strength of the set cement may range from 5 Mpa to 70 MPa, such as 10 MPa to 50 MPa and including from 20 MPa to 40 MPa. In certain embodiments, set products produced from cements of the invention are extremely durable. e.g., as determined using the test method described at ASTM C1157.

### Structures

Aspects of the invention further include structures produced from the cured CO₂ sequestering solids 150 and settable compositions of the invention. As such, further embodiments include manmade structures that contain the CO₂ sequestering solids of the invention and methods of their manufacture. Thus in some embodiments the invention provides a manmade structure that includes one or more cured CO₂ sequestering solids 150 as described herein. The manmade structure may be any structure in which a cured CO₂ sequestering solid may be used, such as a building, dam, levee, roadway or any other manmade structure that incorporates an aggregate or rock. In some embodiments, the invention provides a manmade structure, e.g., a building, a dam, or a roadway, that includes a cured CO₂ sequestering solid 150 of the invention, where in some instances the cured CO₂ sequestering solid 150 may contain CO₂ from a fossil fuel source, e.g., as described above. In some embodiments the invention provides a method of manufacturing a structure, comprising providing an aggregate of the invention.

Notwithstanding the appended claims, the disclosure is also defined by the following clauses:
1. A method of producing a cured CO₂ sequestering solid, the method comprising:
   a) preparing an initial CO₂ sequestering solid composition; and
   b) contacting the initial CO₂ sequestering solid composition with a curing liquid sufficient to produce a cured CO₂ sequestering solid.
2. The method according to Clause 1, wherein the curing liquid comprises a carbonate curing liquid, a bicarbonate curing liquid, a phosphate curing liquid, a divalent alkali earth metal curing liquid or tap water.
3. The method according to Clause 2, wherein the curing liquid comprises a carbonate curing liquid.
4. The method according to Clause 3, wherein the carbonate curing liquid sodium carbonate (Na₂CO₃) ammonium carbonate ((NH₄)₂CO₃) or (K₂CO₃).
5. The method according to Clause 2, wherein the curing liquid comprises a bicarbonate curing liquid.
6. The method according to Clause 5, wherein the bicarbonate curing liquid comprises sodium bicarbonate (NaHCO₃), ammonium bicarbonate (NH₄HCO₃) or potassium bicarbonate (KHCO₃).
7. The method according to any one of Clauses 1-6, wherein the curing liquid has a dissolved inorganic carbon concentration ranging from 0.05 M to 5 M.
8. The method according to Clause 2, wherein the curing liquid comprises a phosphate curing liquid.
9. The method according to Clause 8, wherein the phosphate curing liquid comprises a phosphate anion selected from the group consisting of H₂PO₄⁻, HPO₄²⁻ and PO₄³⁻.
10. The method according to Clause 2, wherein the curing liquid comprises a divalent alkali earth metal curing liquid.
11. The method according to Clause 10, wherein the divalent alkali earth metal curing liquid comprises a calcium curing liquid.
12. The method according to Clause 11, wherein the calcium curing liquid comprises CaCl₂.
13. The method according to Clause 2, wherein the curing liquid comprises tap water.
14. The method according to Clause 2, wherein the curing liquid comprises a composite of two or more curing liquids selected from the group consisting of a carbonate curing liquid, a bicarbonate curing liquid, a phosphate curing liquid, a divalent alkali earth metal curing liquid and tap water.
15. The method according to any one of Clauses 1-14, wherein the curing liquid has a pH ranging from 5 to 14.
16. The method according to any one of Clauses 1-15, wherein the curing liquid is at a temperature ranging from 20° C. to 50° C. for at least a portion of the contacting.
17. The method according to any one of Clauses 1-16, wherein the contacting is performed for between 1 minute and 30 days.
18. The method according to any one of Clauses 1-17, wherein the curing results in a carbonate compound changing from a first crystal structure in the initial CO₂ sequestering solid to a second crystal structure in the cured CO₂ sequestering solid.
19. The method according to Clause 18, wherein the carbonate compound is calcium carbonate, the first crystal structure is vaterite or amorphous calcium carbonate, and the second crystal structure is aragonite or calcite.
20. The method according to any one of Clauses 1-19, wherein preparing the initial CO₂ sequestering solid comprises:
   (i) contacting an aqueous capture liquid with a gaseous source of CO₂ under conditions sufficient to produce a carbonate capture liquid; and
   (ii) combining a cation source and the carbonate capture liquid under conditions sufficient to produce the initial CO₂ sequestering solid.
21. The method according to any one of Clauses 1-19, wherein preparing the initial CO₂ sequestering solid composition comprises contacting an aqueous capture liquid comprising a cation source with a gaseous source of CO₂ under conditions sufficient to produce the initial CO₂ sequestering solid.
22. The method according to Clause 20 or 21, wherein the aqueous capture liquid comprises aqueous capture ammonia and preparing the initial CO₂ sequestering solid composition also results in production of an aqueous ammonium salt.
23. The method according to Clause 22, further comprising regenerating aqueous capture ammonia from the aqueous ammonium salt.
24. The method according to any one of Clauses 20-23, wherein the cation source comprises a divalent alkali earth metal cation.
25. The method according to Clause 24, wherein the divalent alkali earth metal cation is Ca²⁺ or Mg²⁺.
26. The method according to any one of Clauses 20-23, wherein the cation source comprises transition metal cation.
27. The method according to Clause 26, wherein the transition metal cation is a Mn, Fe, Ni, Cu, Co, Zn cation.
28. The method according to any one of Clauses 20-27, further comprising preparing the aqueous capture liquid by at least partially dissolving in an initial aqueous liquid a material selected from the group consisting of cement, concrete, fly ash, rock, and steel slag.
29. The method according to Clause 28, wherein the initial aqueous liquid comprises aqueous ammonia.
30. The method according to any one of Clauses 1 to 29, wherein the initial CO₂ sequestering solid composition comprises a precipitate and the method produces a cured precipitate composition.
31. The method according to Clause 30, wherein the method further comprises producing an aggregate from the cured precipitate composition.
32. The method according to any one of Clauses 1 to 31, wherein the initial CO₂ sequestering solid composition comprising an initial aggregate.
33. The method according to any one of Clauses 1-32, further comprising forming the cured CO₂ sequestering solid into a plurality of cured formed aggregates each having a diameter ranging from 75 μm to 100,000 μm.
34. A cured CO₂ sequestering solid prepared by a process comprising the steps of:
   a) preparing an initial CO₂ sequestering solid composition; and
   b) contacting the initial CO₂ sequestering solid composition with a carbonate curing liquid to produce a cured CO₂ sequestering solid.
35. The cured CO₂ sequestering solid according to Clause 34, wherein the cured CO₂ sequestering solid has a hardness of 2 or greater according to the Mohs Hardness Scale.
36. The cured CO₂ sequestering solid according to any one of Clauses 34-35, wherein concrete specimens containing the cured CO₂ sequestering solid have average 28-day compressive strength and calculated equilibrium density ranging from 2,500 psi to 4,000 psi and 100 lb/ft to 115 lb/ft³, respectively, according to ASTM C330.
37. The cured CO₂ sequestering solid according to any one of Clauses 34-36, wherein the cured CO₂ sequestering solid has a crystalline structure.
38. The cured CO₂ sequestering solid according to Clause 37, wherein the cured CO₂ sequestering solid comprises aragonite, calcite, or a combination thereof.
39. The cured CO₂ sequestering solid according to any one of Clauses 34-38, wherein the cured CO₂ sequestering solid has a diameter ranging from 75 μm to 100,000 μm.
40. A system for producing a cured CO₂ sequestering solid, the system comprising:
   an initial CO₂ sequestering solid composition preparation module; and
   a curing module.
41. The system according to Clause 40, wherein the curing module comprises a curing liquid comprising a carbonate curing liquid, a bicarbonate curing liquid, a phosphate curing liquid, a divalent alkali earth metal curing liquid, or tap water.
42. The system according to Clause 41, wherein the curing liquid comprises sodium carbonate (Na₂CO₃), ammonium carbonate ((NH₄)₂CO₃), potassium carbonate (K₂CO₃), sodium bicarbonate (NaHCO₃), ammonium bicarbonate (NH₄HCO₃), potassium bicarbonate (KHCO₃), a combination thereof.
43. The system according to any one of Clauses 39-42, further comprising an aqueous capture ammonia regeneration module configured to supply aqueous capture ammonia to the aggregate composition preparation module.
44. The system according to Clause 43, wherein the aqueous capture ammonia regeneration module is configured to produce aqueous capture ammonia by distillation.
45. The system according to Clause 43 or 44, wherein the aqueous capture ammonia regeneration module is configured to produce aqueous capture ammonia by contacting an ammonium salt with an alkalinity source.
46. The system according to any one of Clauses 40-45, wherein the initial CO₂ sequestering solid composition preparation module comprises:
   a CO₂ gas/aqueous liquid contactor module; and
   a solid carbonate production module.
47. The system according to any one of Clauses 40-46, wherein the initial CO₂ sequestering solid composition preparation module is configured to contact CO₂ gas with an aqueous liquid comprising a cation source and produce a solid carbonate.
48. The system according to any one of Clauses 40-46, wherein the initial CO₂ sequestering solid composition preparation module is operably coupled to a source of a flue gas.

Notwithstanding the appended claims, the disclosure is also defined by the following clauses:
1. A method of separating an impurity from a CO₂ sequestering solid, the method comprising:
   contacting the CO₂ sequestering solid with steam in a manner sufficient to remove the impurity from the CO₂ sequestering solid.
2. The method according to Clause 1, wherein the CO₂ sequestering solid is contacted with the steam for a time period ranging from 1 to 60 minutes.
3. The method according to Clauses 1 or 2, wherein the CO₂ sequestering solid is contacted with the steam at 0 psig and 100° C.
4. The method according to Clause 3, wherein the CO₂ sequestering solid is contacted with the steam in an open system.
5. The method according to Clauses 1 to 3, wherein the CO₂ sequestering solid is contacted with the steam in a closed system.
6. The method according to Clause 5, wherein the CO₂ sequestering solid is contacted with the steam at a contact pressure greater than atmospheric pressure.
7. The method according to Clause 6, wherein the contact pressure ranges from 1 to 100 psig.
8. The method according to any of Clauses 5 to 7, wherein the temperature ranges from 101 to 170° C.
9. The method according to any of the preceding clauses, wherein the impurity comprises a mediator of a CO₂ sequestering solid production method.
10. The method according to Clause 9, wherein the mediator comprises ammonia, ammonium or a combination thereof.
11. The method according to any of the preceding clauses, wherein the impurity comprises a byproduct of a CO₂ sequestering solid production method.
12. The method according to Clause 11, wherein the byproduct comprises a salt or ion thereof.
13. The method according to Clause 12, wherein the byproduct comprises chloride ion.
14. The method according to any of the preceding clauses, wherein CO₂ sequestering solid comprises an aggregate.
15. The method according to any of the preceding clauses, wherein the method further comprises preparing the CO₂ sequestering solid.
16. The method according to Clause 15, wherein the preparing comprises combining a gaseous source of CO₂ with a capture liquid and a cation source in a manner sufficient to produce the CO₂ sequestering solid.
17. The method according to Clause 15, wherein the gaseous source of CO₂ is combined with the capture liquid under conditions sufficient to produce an aqueous solution comprising carbonate, bicarbonate, dissolved CO₂, or a mixture thereof; followed by combining the cation source and the aqueous solution under conditions sufficient to produce the CO₂ sequestering solid.
18. The method according to Clause 15, wherein preparing the CO₂ sequestering solid composition comprises contacting the aqueous capture liquid comprising the cation source with the gaseous source of CO₂ under conditions sufficient to produce the CO₂ sequestering solid.
19. The method according to any of Clauses 16 to 18, wherein the aqueous capture liquid comprises aqueous capture ammonia and preparing the CO₂ sequestering solid composition also results in production of an aqueous ammonium salt.
20. The method according to Clause 19, further comprising regenerating aqueous capture ammonia from the aqueous ammonium salt.
21. The method according to any one of Clauses 16 to 20, wherein the cation source comprises a divalent alkali earth metal cation.
22. The method according to Clause 21, wherein the divalent alkali earth metal cation is Ca²⁺ or Mg²⁺.
23. The method according to any one of Clauses 16 to 20, wherein the cation source comprises transition metal cation.
24. The method according to Clause 23, wherein the transition metal cation is a Mn, Fe, Ni, Cu, Co, Zn cation.
25. The method according to any one of Clauses 16 to 24, further comprising preparing the aqueous capture liquid by at least partially dissolving in an initial aqueous liquid a material selected from the group consisting of cement, concrete, fly ash, rock, and steel slag.
26. The method according to Clause 25, wherein the initial aqueous liquid comprises aqueous ammonia.
27. The method according to any of the preceding clauses, wherein the method further comprises curing the CO₂ sequestering solid.
28. The method according to Clause 27, wherein the CO₂ sequestering solid is cured before contacting the CO₂ sequestering solid with steam.
29. The method according to Clause 28, wherein the CO₂ sequestering solid is cured after contacting the CO₂ sequestering solid with steam.
30. A treated CO₂ sequestering solid produced according to any of Clauses 1 to 29.
31. A composition comprising a treated CO₂ sequestering solid according to Clause 30.
32. The composition according to Clause 31, wherein the composition comprises a concrete.
33. The composition according to Clause 32, wherein the composition comprises a formed object.
34. A system for producing a treated CO₂ sequestering solid, the system comprising:
   a CO₂ sequestering solid composition preparation module; and
   a steam treatment module.
35. The system according to Clause 34, wherein the steam treatment module is an open module.
36. The system according to Clause 34, wherein the steam treatment module is a closed module.
37. The system according to Clause 36, wherein the steam treatment module is a pressurized module.

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Examples are offered by way of illustration and not by way of limitation. Examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Celsius, and pressure is at or near atmospheric. Standard abbreviations may be used, e.g., bp, base pair(s); kb, kilobase(s); pl, picoliter(s); s or sec, second(s); min, minute(s); h or hr, hour(s); aa, amino acid(s); nt, nucleotide(s); and the like.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

What is claimed is:

1. A method of producing a cured CO₂ sequestering solid, the method comprising:
a) preparing an initial CO₂ sequestering solid composition; and
b) contacting the initial CO₂ sequestering solid composition with a curing liquid sufficient to produce a cured CO₂ sequestering solid.

2. The method according to claim 1, wherein the curing liquid comprises a carbonate curing liquid, a bicarbonate curing liquid, a phosphate curing liquid, a divalent alkali earth metal curing liquid or tap water.

3. The method according to claim 2, wherein the curing liquid comprises a carbonate curing liquid.

4. The method according to claim 3, wherein the carbonate curing liquid comprises sodium carbonate (Na₂CO₃) ammonium carbonate ((NH₄)₂CO₃) or (K₂CO₃).

5. The method according to claim 2, wherein the curing liquid comprises a bicarbonate curing liquid.

6. The method according to claim 5, wherein the bicarbonate curing liquid comprises sodium bicarbonate (NaHCO₃), ammonium bicarbonate (NH₄HCO₃) or potassium bicarbonate (KHCO₃).

7. The method according to any one of claims 1-6, wherein the curing liquid has a dissolved inorganic carbon concentration ranging from 0.05 M to 5 M.

8. The method according to claim 2, wherein the curing liquid comprises a phosphate curing liquid.

9. The method according to claim 8, wherein the phosphate curing liquid comprises a phosphate anion selected from the group consisting of H₂PO₄⁻, HPO₄²⁻ and PO₄³⁻.

10. The method according to claim 2, wherein the curing liquid comprises a divalent alkali earth metal curing liquid.

11. The method according to claim 10, wherein the divalent alkali earth metal curing liquid comprises a calcium curing liquid.

12. The method according to claim 11, wherein the calcium curing liquid comprises CaCl₂.

13. The method according to claim 2, wherein the curing liquid comprises tap water.

14. The method according to claim 2, wherein the curing liquid comprises a composite of two or more curing liquids selected from the group consisting of a carbonate curing liquid, a bicarbonate curing liquid, a phosphate curing liquid, a divalent alkali earth metal curing liquid and tap water.

15. The method according to any one of claims 1-14, wherein the curing liquid has a pH ranging from 5 to 14.

16. The method according to any one of claims 1-15, wherein the curing liquid is at a temperature ranging from 20° C. to 50° C. for at least a portion of the contacting.

17. The method according to any one of claims 1-16, wherein the contacting is performed for between 1 minute and 30 days.

18. The method according to any one of claims 1-17, wherein the curing results in a carbonate compound changing from a first crystal structure in the initial CO₂ sequestering solid to a second crystal structure in the cured CO₂ sequestering solid.

19. The method according to claim 18, wherein the carbonate compound is calcium carbonate, the first crystal structure is vaterite or amorphous calcium carbonate, and the second crystal structure is aragonite or calcite.

20. The method according to any one of claims 1-19, wherein preparing the initial CO₂ sequestering solid comprises including:
(i) contacting an aqueous capture liquid with a gaseous source of CO₂ under conditions sufficient to produce a carbonate capture liquid; and
(ii) combining a cation source and the carbonate capture liquid under conditions sufficient to produce the initial CO₂ sequestering solid.

21. The method according to any one of claims 1-19, wherein preparing the initial CO₂ sequestering solid composition comprises contacting an aqueous capture liquid comprising a cation source with a gaseous source of CO₂ under conditions sufficient to produce the initial CO₂ sequestering solid.

22. The method according to claim 20 or 21, wherein the aqueous capture liquid comprises aqueous capture ammonia and preparing the initial CO₂ sequestering solid composition also results in production of an aqueous ammonium salt.

23. The method according to claim 22, further comprising regenerating aqueous capture ammonia from the aqueous ammonium salt.

24. The method according to any one of claims 20-23, wherein the cation source comprises a divalent alkali earth metal cation.

25. The method according to claim 24, wherein the divalent alkali earth metal cation is Ca²⁺ or Mg²⁺.

26. The method according to any one of claims 20-23, wherein the cation source comprises transition metal cation.

27. The method according to claim 26, wherein the transition metal cation is a Mn, Fe, Ni, Cu, Co, Zn cation.

28. The method according to any one of claims 20-27, further comprising preparing the aqueous capture liquid by at least partially dissolving in an initial aqueous liquid a material selected from the group consisting of cement, concrete, fly ash, rock, and steel slag.

29. The method according to claim 28, wherein the initial aqueous liquid comprises aqueous ammonia.

30. The method according to any one of claims 1 to 29, wherein the initial CO₂ sequestering solid composition comprises a precipitate and the method produces a cured precipitate composition.

31. The method according to claim 30, wherein the method further comprises producing an aggregate from the cured precipitate composition.

32. The method according to any one of claims 1 to 29, wherein the initial CO₂ sequestering solid composition comprising an initial aggregate.

33. The method according to any one of claims 1-32, further comprising forming the cured CO₂ sequestering solid into a plurality of cured formed aggregates each having a diameter ranging from 75 μm to 100,000 μm.

34. The method according to any one of claims 1-33, wherein the method further comprises contacting the cured CO₂ sequestering solid with steam in a manner sufficient to remove an impurity from the CO₂ sequestering solid.

35. The method according to claim 34, wherein the CO₂ sequestering solid is contacted with the steam for a time period ranging from 1 to 60 minutes.

36. The method according to any one of claims 34-35, wherein the CO₂ sequestering solid is contacted with the steam at 0 psig and 100° C.

37. The method according to claim 36, wherein the CO₂ sequestering solid is contacted with the steam in an open system.

38. The method according to any one of claims 34-36, wherein the CO₂ sequestering solid is contacted with the steam in a closed system.

39. The method according to claim 38, wherein the CO₂ sequestering solid is contacted with the steam at a contact pressure greater than atmospheric pressure.

40. A cured CO₂ sequestering solid prepared by a process comprising the steps of:
a) preparing an initial CO₂ sequestering solid composition; and
b) contacting the initial CO₂ sequestering solid composition with a carbonate curing liquid to produce a cured CO₂ sequestering solid.

41. The solid according to claim 40, wherein the cured CO₂ sequestering solid has a hardness of 2 or greater according to the Mohs Hardness Scale.

42. The solid according to any one of claims 40-41, wherein concrete specimens containing the cured CO₂ sequestering solid have average 28-day compressive strength and calculated equilibrium density ranging from 2,500 psi to 4,000 psi and 100 lb/ft to 115 lb/ft³, respectively, according to ASTM C330.

43. The solid according to any one of claims 40-42, wherein the cured CO₂ sequestering solid has a crystalline structure.

44. The solid according to claim 43, wherein the cured CO₂ sequestering solid comprises aragonite, calcite, or a combination thereof.

45. The solid according to any one of claims 40-44, wherein the cured CO₂ sequestering solid has a diameter ranging from 75 μm to 100,000 μm.

46. A system for producing a cured CO₂ sequestering solid, the system comprising:
an initial CO₂ sequestering solid composition preparation module; and
a curing module.

47. The system according to claim 46, wherein the curing module comprises a curing liquid comprising a carbonate curing liquid, a bicarbonate curing liquid, a phosphate curing liquid, a divalent alkali earth metal curing liquid, or tap water.

48. The system according to claim 47, wherein the curing liquid comprises sodium carbonate (Na₂CO₃), ammonium carbonate ((NH₄)₂CO₃), potassium carbonate (K₂CO₃), sodium bicarbonate (NaHCO₃), ammonium bicarbonate (NH₄HCO₃), potassium bicarbonate (KHCO₃), a combination thereof.

49. The system according to any one of claims 46-48, further comprising an aqueous capture ammonia regeneration module configured to supply aqueous capture ammonia to the aggregate composition preparation module.

50. The system according to claim 49, wherein the aqueous capture ammonia regeneration module is configured to produce aqueous capture ammonia by distillation.

51. The system according to any one of claims 49-50, wherein the aqueous capture ammonia regeneration module is configured to produce aqueous capture ammonia by contacting an ammonium salt with an alkalinity source.

52. The system according to any one of claims 46-51, wherein the initial CO₂ sequestering solid composition preparation module comprises:
a CO₂ gas/aqueous liquid contactor module; and
a solid carbonate production module.

53. The system according to any one of claims 46-51, wherein the initial CO₂ sequestering solid composition preparation module comprises a CO₂ gas/aqueous liquid contactor module configured to contact CO₂ gas with an aqueous liquid comprising a cation source and produce a solid carbonate.

54. The system according to any one of claims 46-53, wherein the initial CO₂ sequestering solid composition preparation module is operably coupled to a source of a flue gas.
